(19) United States
(12) Patent Application Publication
(10) Pub. No.: US 2017/0280342 A1
(43) Pub. Date: Sep. 28, 2017

(54) MEASUREMENT APPARATUS, MEASUREMENT METHOD, AND COMMUNICATION SYSTEM

(71) Applicant: FUJITSU LIMITED, Kawasaki-shi (JP)

(72) Inventors: Taichi SUGIYAMA, Kawasaki (JP); Kazuo Mizuta, Miyaki (JP); Tomohiro Muramoto, Yokohama (JP); Eri Horita, Yokohama (JP)

(73) Assignee: FUJITSU LIMITED, Kawasaki-shi (JP)

(21) Appl. No.: 15/464,575

(22) Filed: Mar. 21, 2017

(30) Foreign Application Priority Data
Mar. 28, 2016 (JP) 2016-064588

(51) Int. Cl. H04W 24/10; H04W 56/00

(52) U.S. Cl. CPC H04W 24/10; H04W 56/0065; H04W 88/08

(57) ABSTRACT

A measurement apparatus includes a communication device configured to obtain a packet being transmitted between a server apparatus and a communication apparatus in a network, a memory, and a processor coupled to the memory and configured to calculate round-trip time between the communication apparatus and the server apparatus, and measure a data transfer rate between the communication apparatus and the server apparatus based on a data volume included in a second packet having a length equal to or greater than the threshold and transmitted to the communication apparatus from the server apparatus, a period of time from time at which the second packet is acquired to time at which an acknowledgement packet transmitted in response to the second packet is acquired, and the round-trip time.

### CROSS-REFERENCE TO RELATED APPLICATION

This application is based upon and claims the benefit of priority of the prior Japanese Patent Application No. 2016-064588, filed on Mar. 28, 2016, the entire contents of which are incorporated herein by reference.

### FIELD

The embodiments relate to a measurement apparatus, a measurement method, and a communication system.

### BACKGROUND

Since high-speed communication is now available by wireless communication technology, such as Long Term Evolution (LTE) and Wireless Fidelity (Wi-Fi), an increasing number of users currently use wireless terminals. Even in a system to which a technique with which high-speed communication is possible is applied, throughput may be reduced due to, for example, occurrence of a failure. A reduced throughput may cause a decrease in user's operating efficiency and a decrease in user's satisfaction with a service provider. Therefore, if throughput is reduced, it is desirable to detect the reduction in throughput early and recover the same. For that purpose, it is desirable to measure throughput precisely.

As a related technique, an apparatus which determines the number of times that data is transmitted collectively in a unit of window size in a connection of monitoring target based on the total data volume transmitted to a mobile terminal from a server and an initial window size at the time of starting data communication is proposed. In this apparatus, communication quality is measured separately in sessions in which the number of times of collective transmission is one and sessions in which the number of times of collective transmission is two or more (for example, see Japanese Laid-open Patent Publication No. 2013-38749). Further, a method for calculating throughput from time for transmission and reception of a Syn packet and a SynAck packet which are transmitted and received between a communication terminal and an information server and each of which includes additional padding information is proposed (for example, see Japanese Laid-open Patent Publication No. 2000-278320). Further, a control method for lowering an occurrence rate of a radio error if a radio error has occurred and throughput in a higher-order layer than a radio layer is smaller than throughput in the radio layer calculated using an occurrence rate of the radio error is proposed (for example, see Japanese Laid-open Patent Publication No. 2014-53708). Further, rate control with the maximum throughput calculated based on a period excluding a period with no contribution to data transmission and reception or the maximum throughput calculated based on receiving intervals of continuous transmission packets measured by a client being the upper limit is proposed (for example, see Japanese Laid-open Patent Publication No. 2006-279283).

### SUMMARY

According to an aspect of the invention, a measurement apparatus includes a communication device configured to obtain a packet being transmitted between a server apparatus and a communication apparatus in a network, a memory, and a processor coupled to the memory and configured to calculate round-trip time between the communication apparatus and the server apparatus based on a period of time from time at which a first packet having a length less than a threshold and transmitted to the communication apparatus from the server apparatus is acquired to time at which an acknowledgement packet transmitted in response to the first packet is acquired, and measure a data transfer rate between the communication apparatus and the server apparatus based on a data volume included in a second packet having a length equal to or greater than the threshold and transmitted to the communication apparatus from the server apparatus, a period of time from time at which the second packet is acquired to time at which an acknowledgement packet transmitted in response to the second packet is acquired, and the round-trip time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary communication system;

FIG. 2 illustrates an exemplary measurement method according to an embodiment;

FIG. 3 illustrates an exemplary configuration of a measurement apparatus;

FIG. 4 illustrates an exemplary hardware configuration of the measurement apparatus;

FIGS. 5A and 5B illustrate an exemplary method for generating a connection management table;

FIG. 6 illustrates an exemplary connection management table;

FIG. 7 illustrates an exemplary measurement method according to a first embodiment;

FIG. 8 is a flowchart illustrating an exemplary process performed in the measurement apparatus;

FIGS. 9A and 9B are flowcharts illustrating an exemplary measurement process;

FIG. 10 illustrates an exemplary measurement method according to a second embodiment;

FIG. 11 is a flowchart illustrating an exemplary process performed in the measurement apparatus;

FIG. 12 is a flowchart illustrating an exemplary aggregated process;

FIG. 13 illustrates an exemplary network;

FIG. 14 illustrates an exemplary network information table;

FIG. 15 illustrates an exemplary aggregated process;

FIG. 16 illustrates an exemplary aggregated process;

FIG. 17 illustrates an exemplary change in throughput;

FIG. 18 illustrates an exemplary comparison process of communication quality;

FIG. 19 illustrates exemplary information indicating a relationship between movement of a user and throughput; and

FIG. 20 illustrates an exemplary packet used for RTT measurement.

### DESCRIPTION OF EMBODIMENTS

In a system including a section in which wireless communication is performed, since a communication state in a wireless section is liable to changes, round-trip time of a packet is liable to changes. In a process based on an initial window size or time for transmission and reception of a control packet at the time of starting communication, round-trip time used for calculation may deviate from an actual value once communication quality changes in a wireless section. Therefore, an obtained value of throughput may become inaccurate. Even if any of the techniques described above as related techniques is applied, it is difficult to precisely calculate throughput in a system including a network of which round-trip time is liable to changes.

In an aspect thereof, the embodiment calculates throughput precisely.

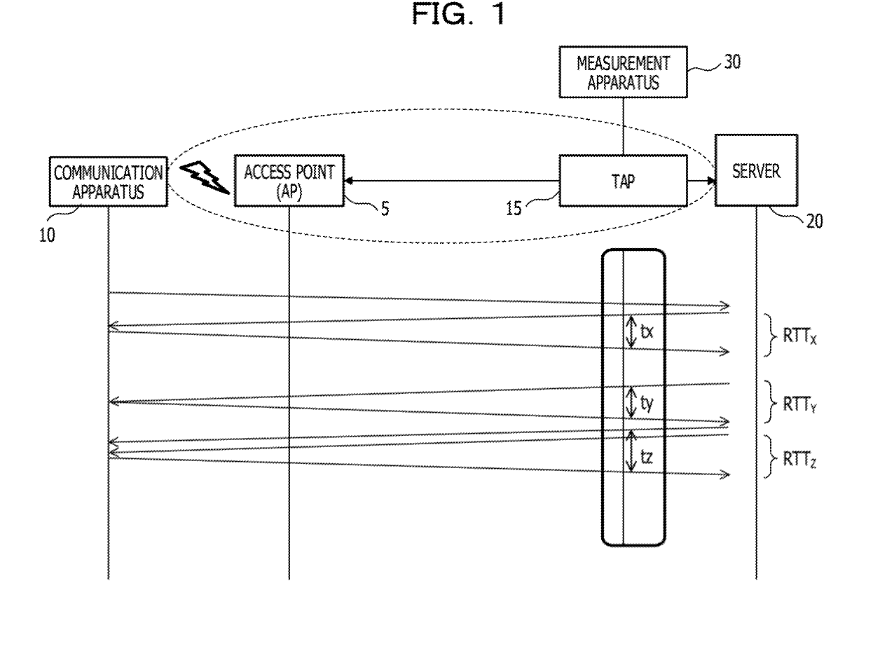

FIG. 1 illustrates an exemplary communication system.

The communication system includes a communication apparatus 10, an access point 5, a TAP 15, a server 20, and a measurement apparatus 30. The communication apparatus 10 communicates with the server 20 via the access point 5. The TAP 15 outputs a packet transmitted and received between the access point 5 and the server 20 to the measurement apparatus 30. The measurement apparatus 30 calculates round-trip time (RTT) between the communication apparatus 10 and the server 20, and throughput of data by analyzing the packet input from the TAP 15. Hereinafter, a data transfer rate will be referred to as “throughput.”

Here, the TAP 15 is disposed at a position physically close to the server 20 so that time until the packet arrives at the server 20 from the communication apparatus 10 and time until the packet arrives at the TAP 15 from the communication apparatus 10 may become substantially the same. Time until the packet arrives at the measurement apparatus 30 from the TAP 15 and time until the packet arrives at the TAP 15 from the measurement apparatus 30 are assumed to be negligible with respect to the round-trip time between the communication apparatus 10 and the server 20. Therefore, the round-trip time between the communication apparatus 10 and the server 20 may be approximated to the round-trip time between the communication apparatus 10 and the measurement apparatus 30. Time at which the measurement apparatus 30 acquires the packet addressed to the communication apparatus 10 is approximated to time at which the server 20 transmits the packet to the communication apparatus 10. Time at which the measurement apparatus 30 acquires the packet addressed to the server 20 transmitted from the communication apparatus 10 is approximated to time at which the server 20 receives the packet from the communication apparatus 10.

For example, the round-trip time of the packet between the server 20 and the communication apparatus 10 is assumed to be RTTₓ. A time period from time at which a first packet transmitted from the server 20 is transmitted to the communication apparatus 10 from the TAP 15 to time at which a second packet transmitted from the communication apparatus 10 as a response to the first packet arrives at the TAP 15 is assumed to be tx. In this case, RTTₓ may be handled as the same value as tx. Round-trip delay between the communication apparatus 10 and the measurement apparatus 30 may also be approximated to RTT_{X} or tx.

Since communication between the communication apparatus 10 and the access point 5 is wireless communication, communication quality in the section between the communication apparatus 10 and the access point 5 is liable to changes compared with other sections. However, even if the communication quality is changed after the communication starts, the round-trip time of the packet between the server 20 and the communication apparatus 10 may be approximated to the round-trip time of the packet between the measurement apparatus 30 and the communication apparatus 10. Therefore, assuming that round-trip time of the packet between the measurement apparatus 30 and the communication apparatus 10 is ty when the round-trip time of the packet between the server 20 and the communication apparatus 10 is RTT_{y}, a difference between RTT_{y} and ty is negligible.

When delayed acknowledgment (delayed ACK) is used, the round-trip time between the communication apparatus 10 and the server 20 may be similarly approximated to the round-trip time of the packet between the measurement apparatus 30 and the communication apparatus 10. For example, a difference in the round-trip time between the communication apparatus 10 and the server 20 in a case where Ack for two packets are transmitted at once (RTT_{z}) and the round-trip time of the packet between the measurement apparatus 30 and the communication apparatus 10 (tz) is negligible because of the delayed ACK.

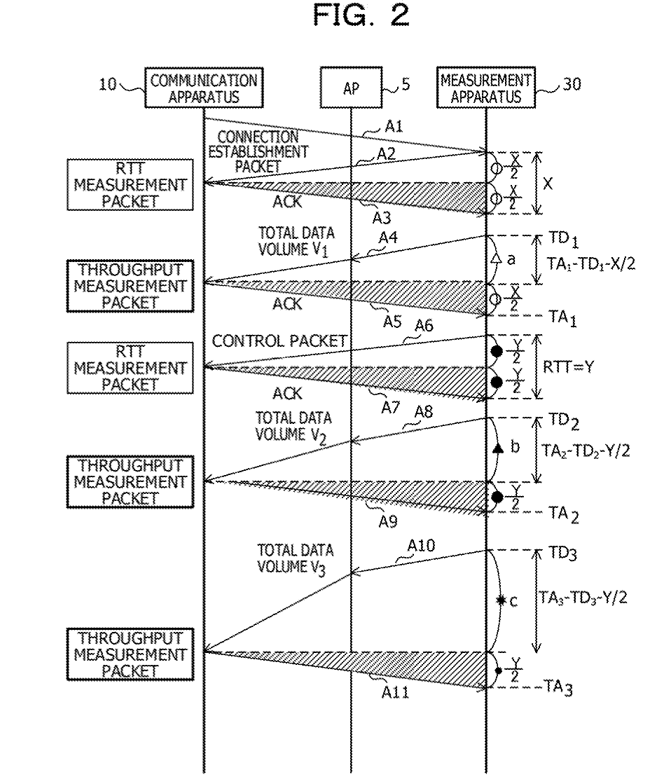

FIG. 2 illustrates an exemplary measurement method according to an embodiment. For the ease of illustration, the server 20 and the TAP 15 are not illustrated in FIG. 2. The packet transmitted and received between the communication apparatus 10 and the server 20 is described as a round trip of the packet between the communication apparatus 10 and the measurement apparatus 30. Correctly, the packet which arrives at the measurement apparatus 30 from the communication apparatus 10 is transmitted from the communication apparatus 10 to the server 20 and arrives at the measurement apparatus 30 via the TAP 15. A flow of the packet toward the communication apparatus 10 from the measurement apparatus 30 is a flow of the packet transmitted to the communication apparatus 10 from the server 20. The packet transmitted to the communication apparatus 10 from the server 20 arrives at the measurement apparatus 30 via the TAP 15 substantially simultaneously with the transmission from the server 20.

In the description below, the measurement apparatus 30 is assumed to store in advance a packet length of a packet including a data volume of magnitude with which process delay accompanying data transfer or an increase in transfer time are negligible as a threshold. A packet which does not store user data, like a control packet, is also included in the packet including a data volume of magnitude with which process delay accompanying data transfer or an increase in transfer time. For example, a threshold used when determining whether a packet is to be used for measurement of the RTT may be a length of a packet which does not include user data, an average value of packet length which does not include user data, for example. The measurement apparatus 30 performs calculation and correction of the RTT using a packet of which packet length is less than a threshold and a response packet to that packet.

Assuming that the communication apparatus 10 has transmitted an establishment request of a connection (a SYN packet) as indicated by an arrow A1 to establish communication between the communication apparatus 10 and the server 20. The establishment request of a connection arrives at the server 20 and the measurement apparatus 30 via the access point 5.

An arrow A2 represents a state that a connection establishment packet (a SYN+ACK packet) which the server 20 transmits in response to the establishment request of a connection is arriving at the communication apparatus 10. At the same time with the transmission of the connection establishment packet from the server 20, the measurement apparatus 30 receives the connection establishment packet from the server 20. The measurement apparatus 30 stores reception time of the connection establishment packet as transmission time of the packet to the communication apparatus 10 from the server 20. Since the packet length of the connection establishment packet is less than a threshold, the measurement apparatus 30 recognizes that the packet usable for the calculation of the RTT has been transmitted to the communication apparatus 10 from the server 20.

When the connection establishment packet is received, the communication apparatus 10 transmits an ACK packet to the server 20 as a response to the connection establishment packet (an arrow A3). When the ACK packet is received via the TAP 15, the measurement apparatus 30 determines that a response of the packet transmitted toward the communication apparatus 10 as indicated by the arrow A2 has been obtained. Then, the measurement apparatus 30 calculates a time period from the reception time of the connection establishment packet to the reception time of the ACK packet as the RTT between the communication apparatus 10 and the server 20. Assuming that the RTT between the communication apparatus 10 and the server 20 is calculated to be X from the arrow A2 and the arrow A3.

Next, assuming that the server 20 has transmitted a data packet including data of an amount of V₁ to the communication apparatus 10 at time TD₁ (an arrow A4). Assuming that the measurement apparatus 30 has received an ACK packet in response to the data packet at time TA₁ (an arrow A5). Then, the measurement apparatus 30 calculates throughput using a ½ value of the RTT as time until the ACK packet arrives at the server 20 from the communication apparatus 10. That is, the measurement apparatus 30 calculates time a taken until the data packet transmitted from the server 20 as indicated by the arrow A4 arrives at the communication apparatus 10 to be a=TA₁−TD₁−X/2. The measurement apparatus 30 calculates throughput at the time of transmission of the packet as indicated by the arrow A4 to be V₁/a.

Assuming that the server 20 has transmitted the control packet to the communication apparatus 10 as indicated by the arrow A6. Since a packet length of the control packet is less than a threshold, the measurement apparatus 30 determines to use the control packet transmitted as indicated by the arrow A6 for recalculation of the RTT. The measurement apparatus 30 sets a time period from time at which the control packet transmitted along arrow A6 is acquired via the TAP 15 to time until an ACK packet in response to the control packet is received to be a new RTT. Assuming that the RTT between the communication apparatus 10 and the server 20 is calculated to be Y from the arrow A6 and the arrow A7. Then, the measurement apparatus 30 calculates throughput thereafter using RTT=Y. [0022] For example, assuming that the server 20 has transmitted a data packet including data of an amount of V₂ to the communication apparatus 10 at time TD₂ (an arrow A8). Assuming that the measurement apparatus 30 has received an ACK packet in response to the data packet at time TA₂ (an arrow A9). Then, the measurement apparatus 30 calculates time b taken until the data packet transmitted as indicated by the arrow A8 arrives at the communication apparatus 10 to be b=TA₂−TD₂−Y/2. Then, the measurement apparatus 30 calculates throughput at the time of transmission of the packet as indicated by the arrow A8 to be V₂/b.

Similarly, assuming that the server 20 has transmitted a data packet including data of an amount of V₃ to the communication apparatus 10 at time TD₃, and the measurement apparatus 30 has received an ACK packet in response to the data packet at time TA₃ (arrows A10 and A11). Then, the measurement apparatus 30 calculates time c taken until the data packet transmitted as indicated by the arrow A10 arrives at the communication apparatus 10 to be c=TA₃−TD₃−Y/2, and then calculates throughput at the time of transmission of the packet as indicated by the arrow A10 to be V₃/c.

As described above, the measurement apparatus 30 may calculate throughput precisely by using a packet of which packet length is less than a threshold for calculation of RTT, and using the newest RTT together with time taken for transmission and reception of a data packet and a data volume in the data packet.

Configuration of Apparatus

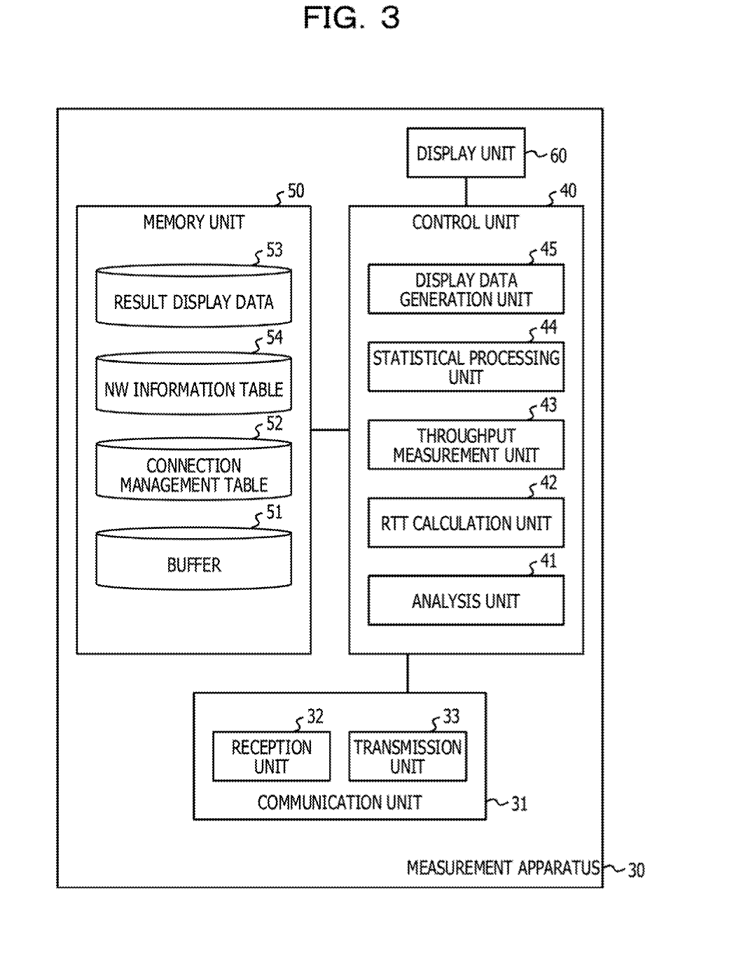

FIG. 3 illustrates an exemplary configuration of a measurement apparatus 30. The measurement apparatus 30 includes a communication unit 31, a control unit 40, a memory unit 50, and a display unit 60. The communication unit 31 includes a reception unit 32 and a transmission unit 33. The control unit 40 includes an analysis unit 41, an RTT calculation unit 42, and a throughput measurement unit 43. The control unit 40 may optionally include a statistical processing unit 44 and a display data generation unit 45.

The memory unit 50 operates as a buffer 51, and stores a connection management table 52 and result display data 53. The measurement apparatus 30 may optionally store a network (NW) information table 54 in the memory unit 50. The connection management table 52 stores information about a connection used for the communication by the packet received by the measurement apparatus 30 via the TAP 15, information about transmission and reception of a packet in each connection, for example. The result display data 53 is used when displaying a measurement result of throughput on the display unit 60. The NW information table 54 records information about arrangement of the access points 5 in the network, a range of an IP address assigned by each access point 5, for example.

The reception unit 32 receives packets from other devices, and the transmission unit 33 transmits packets to other devices. The reception unit 32 outputs a received packet to the buffer 51. By analyzing a received packet, the analysis unit 41 specifies a connection in which communication is performed using the packet.

If the packet length of a received packet is less than a predetermined threshold, the RTT calculation unit 42 calculates RTT between the communication apparatus 10 and the server 20 using an ACK packet to the received packet. The throughput measurement unit 43 calculates throughput using the newest RTT value calculated by the RTT calculation unit 42, reception time of a packet of which packet length is equal to or greater than a threshold, reception time of an ACK packet in response to the packet of which packet length is equal to or greater than a threshold, and a data volume in the packet. The display data generation unit 45 generates the result display data 53 as display data for displaying RTT, a measurement result of throughput, for example. The display unit 60 is a display device, for example, and displays the result display data 53 on a screen.

The statistical processing unit 44 performs a statistical process using calculated throughput and a connection relationship in a network specified by using information in the NW information table 54. In the measurement apparatus 30 provided with the statistical processing unit 44, the display data generation unit 45 generates the result display data 53 using information acquired in the RTT calculation unit 42, the throughput measurement unit 43, and the statistical processing unit 44.

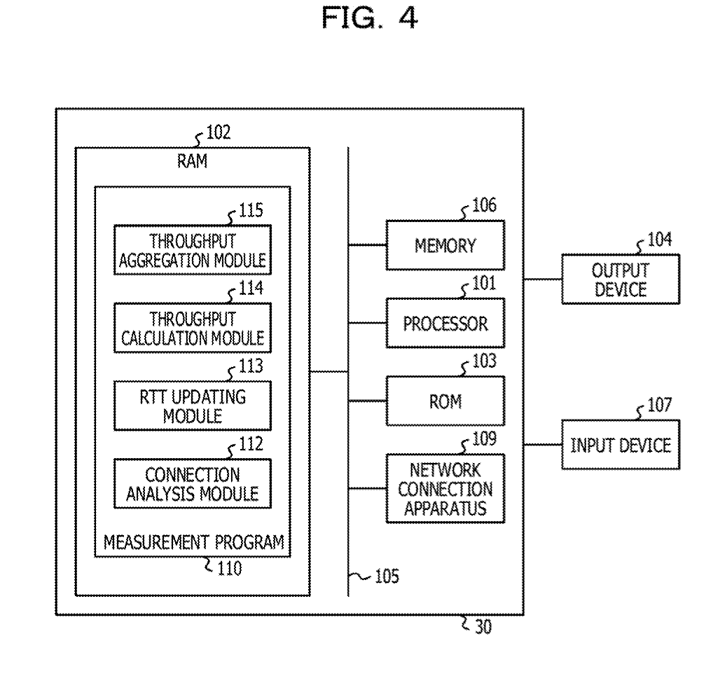

FIG. 4 illustrates an exemplary hardware configuration of the measurement apparatus 30. The measurement apparatus 30 includes a processor 101, random access memory (RAM) 102, read only memory (ROM) 103, a bus 105, a memory 106, and a network connection apparatus 109. The bus 105 connects the processor 101, the RAM 102, the ROM 103, memory 106, and the network connection apparatus 109 so that data may input and output thereamong. The processor 101 may be any processing circuit including a central processing unit (CPU), and may execute a measurement program 110 using the RAM 102 as a work area. The ROM 103 and the memory 106 are used for storing information used for the process in the measurement program 110 or the processor 101. The measurement program 110 includes a connection analysis module 112, an RTT updating module 113, a throughput calculation module 114, and a throughput aggregation module 115.

The measurement apparatus 30 may further include an output device 104 and an input device 107, any of which may be connected with the measurement apparatus 30. The output device 104 may be a monitor which includes a screen. Examples of the monitor may include a cathode ray tube (CRT), a thin film transistor (TFT), a liquid crystal display, and a plasma display. The input device 107 is an arbitrary device, such as a mouse and a keyboard, for inputting data. The network connection apparatus 109 is connected with a network, such as a local area network (LAN), a wide area network (WAN), and the Internet, via a communication line, and communicates with other devices via the network. A LAN adapter, a modem, for example, may be used as the network connection apparatus 109.

The processor 101 operates as the control unit 40. The analysis unit 41 is implemented by the connection analysis module 112 executed by the processor 101. Similarly, the processor 101 implements the RTT calculation unit 42 by executing the RTT updating module 113, implements the throughput measurement unit 43 by executing the throughput calculation module 114, and implements the statistical processing unit 44 by executing the throughput aggregation module 115. The RAM 102, the ROM 103, and the memory 106 operate as the memory unit 50. The network connection apparatus 109 operates as the communication unit 31.

### First Embodiment

Hereinafter, an exemplary process performed in a first embodiment will be described regarding a method for generating the connection management table 52, measurement of RTT, and measurement of throughput. Although a case where a transmission control protocol (TCP) is used as an example is described below, any protocols including transmission and reception of an acknowledgement of a packet may be used for the communication between the communication apparatus 10 and the server 20.

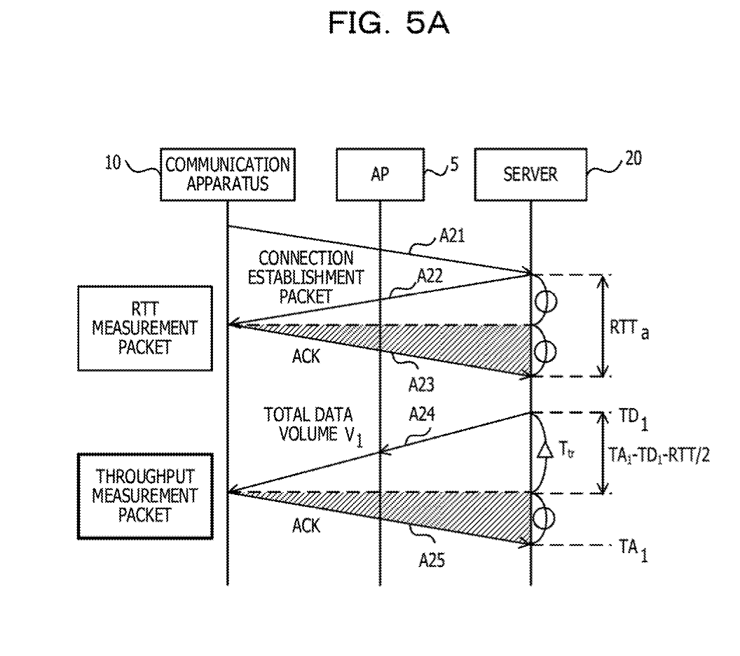

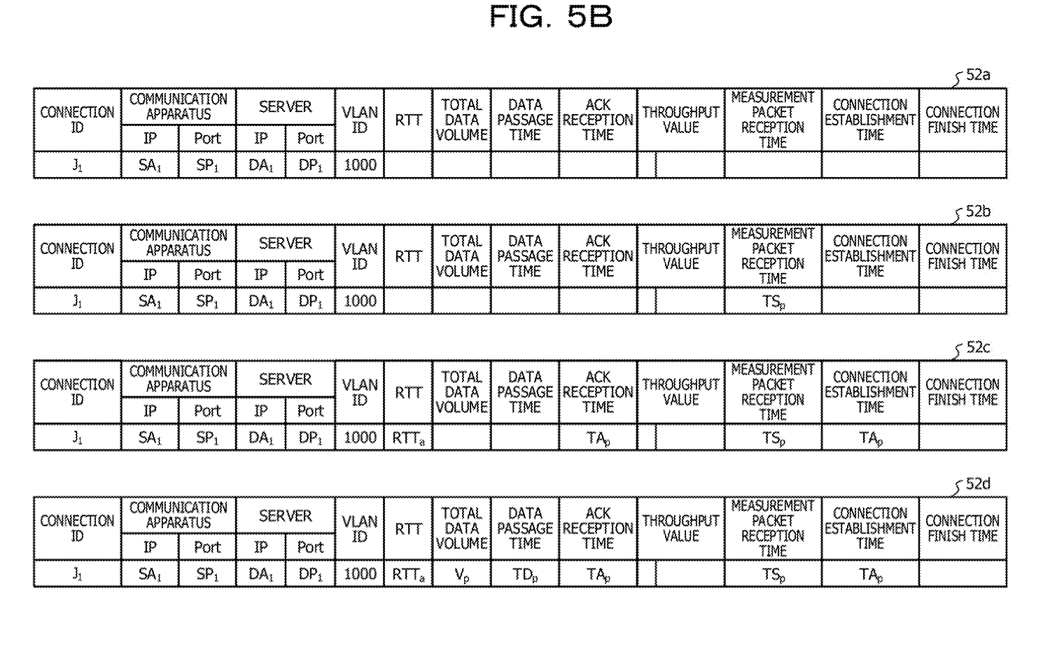

FIG. 5A and FIG. 5B illustrate an exemplary method for generating the connection management table 52. Information about a packet transmitted and received via a connection is recorded in the connection management table 52 for each connection. In the example of FIG. 5B, the connection management table 52 includes a connection ID, an IP address and a port number of a transmission source of a connection request of a connection, and an IP address and a port number of an address of a connection request of a connection. In the example of FIG. 5A, establishment of a connection is requested from the communication apparatus 10 to the server 20. The connection management table 52 further includes a VLAN ID, RTT, a total data volume, data passage time, acknowledgement (ACK) reception time, a throughput value, measurement packet reception time, connection establishment time, connection finish time, for example.

The VLAN ID is information for identifying a virtual local area network (VLAN) used for the communication established using a SYN packet. The RTT is obtained about a connection specified by the connection ID in the entries. The total data volume is an amount of data transmitted to the communication apparatus 10 from the server 20 while transmission of an ACK from the communication apparatus 10 is performed. The data passage time is time at which the measurement apparatus 30 receives a data packet transmitted to the communication apparatus 10 from the server 20. The ACK reception time is time at which the measurement apparatus 30 receives an acknowledgement packet (ACK packet) transmitted to the server 20 from the communication apparatus 10. The throughput value is the throughput obtained about the connection specified by the connection ID.

The measurement packet reception time is time when the measurement apparatus 30 received a packet usable for the calculation of RTT. In this specification, the packet usable for the calculation of RTT may be referred to as a “measurement packet.” The measurement packet may be, for example, any packet of which packet length is equal to or shorter than a threshold. When a connection is established, a connection establishment packet (a SYN+ACK packet) is used as the measurement packet. The connection establishment time is time at which the connection specified by the connection ID is established, and the connection finish time is time at which the connection specified by the connection ID is finished.

Hereinafter, exemplary update of data in the connection management table 52 will be described with reference to a case where transmission and reception of packets along arrows A21 to A25 are performed.

as indicated by the arrow A21, the communication apparatus 10 transmits an establishment request of a connection to the server 20 via the access point 5. Hereinafter, an establishment request of a connection transmitted to a request destination from a device which requests establishment of a connection will be referred to as a SYN packet. When a SYN packet is transmitted to the server 20, the reception unit 32 in the measurement apparatus 30 receives the SYN packet via the TAP 15. The reception unit 32 stores the SYN packet in the buffer 51. By analyzing the SYN packet stored in the buffer 51, the analysis unit 41 specifies an IP address and a port number about each of the communication apparatus 10 which requested the communication and the server 20 which is the communication destination. The analysis unit 41 also specifies a VLAN ID from the SYN packet. The analysis unit 41 determines ID to identify a connection to be established with the SYN packet, correlates the information specified by the SYN packet with a connection ID, and records the information in the connection management table 52. For example, assuming that the SYN packet transmitted to the server 20 from the communication apparatus 10 includes the following information:

IP address of transmission source: SA₁

Port number of transmission source: SP₁

IP address of destination: DA₁

Port number of destination: DP₁

VLAN ID: 1000.

Further, assuming that the analysis unit 41 generates a connection ID=J₁ with respect to a connection established with the SYN packet. In this case, the analysis unit 41 stores the obtained information in a connection management table 52a as illustrated in FIG. 5.

Next, the server 20 transmits a connection establishment packet (a SYN+ACK packet) to the communication apparatus 10 as indicated by the arrow A22. Then, the measurement apparatus 30 receives the SYN+ACK packet via the TAP 15. The reception unit 32 in the measurement apparatus 30 stores the received SYN+ACK packet in the buffer 51. Since a packet length of the SYN+ACK packet is shorter than a threshold, the analysis unit 41 determines to use the SYN+ACK packet in the measurement of RTT. The analysis unit 41 stores reception time of the SYN+ACK packet (TSₚ) as the measurement packet reception time. Therefore, the connection management table 52a is updated as illustrated in a connection management table 52b.

In response to the SYN+ACK packet, the communication apparatus 10 transmits a response packet (an ACK packet) to the server 20 (the arrow A23). Then, the measurement apparatus 30 receives the ACK packet. When the ACK packet is stored in the buffer 51, the analysis unit 41 stores the reception time of the ACK packet (TAₚ) as ACK reception time. The analysis unit 41 applies the reception time of the ACK packet as the establishment time of the connection. The analysis unit 41 records the obtained information in the connection management table 52 and requests calculation of RTT to the RTT calculation unit 42.

The RTT calculation unit 42 calculates a difference between the measurement packet reception time and the ACK reception time in the connection management table 52 as RTT. Here, when the measurement packet reception time is subtracted from the ACK reception time, the following equation is assumed to hold: TAₚ−TSₚ=RTTₐ. Then, the RTT calculation unit 42 records RTTₐ in the connection management table 52 as RTT of the connection ID=J₁. The connection management table 52b is updated by a process of the analysis unit 41 and the RTT calculation unit 42 as shown in the connection management table 52c.

as indicated by an arrow A24, a data packet is assumed to be transmitted to the communication apparatus 10 from the server 20. When the data packet is received, the measurement apparatus 30 analyzes the data packet in the analysis unit 41 in the same manner as the control packet. The analysis unit 41 is assumed to acquire the following information about the data packet:

Total data volume: Vₚ

Reception time of data packet: TDₚ.

The analysis unit 41 compares the packet length with a previously stored threshold and determines whether the received packet is a packet used for the update of RTT. Here, the packet length of the data packet is assumed to be greater than the threshold. Then, the analysis unit 41 determines that not a packet used for the update of RTT but a packet used for the calculation of throughput has been received, and records the obtained information in the connection management table 52. In the example of FIG. 5, the analysis unit 41 updates the connection management table 52c as illustrated in the connection management table 52d.

The ACK packet is assumed to be transmitted from the communication apparatus 10 to the server 20 as indicated by the arrow A25. The ACK packet is received by both the server 20 and the measurement apparatus 30. The analysis unit 41 determines that the received packet is the ACK packet in the same connection as that of the packet received as indicated by the arrow A24 from the information, such as an address in the packet received by the measurement apparatus 30, for example. Then, the analysis unit 41 requests calculation of the throughput to the throughput measurement unit 43.

Here, assuming that the reception time of the ACK packet is TA₁. Then, the throughput measurement unit 43 sets half the time of RTT of a time period from passage time of the data packet to the reception time of the ACK packet to be time taken by the ACK packet to arrive at the server 20 from the communication apparatus 10. Therefore, the throughput measurement unit 43 calculates time Ttr taken until the data packet arrives at the communication apparatus 10 from the server 20 from the equation: Ttr=TA₁−TD₁−RTT/2. The data volume in the data packet transmitted to the communication apparatus 10 from the server 20 as indicated by the arrow A24 is Vₚ. Then, the throughput measurement unit 43 calculates a throughput value (Thr) between the server 20 and the communication apparatus 10 from the equation: Thr=Vₚ/Ttr. The throughput measurement unit 43 records the obtained value in a column of the connection of the packet of process target in the connection management table 52. The same process is performed whenever the packet is transmitted and received between the server 20 and the communication apparatus 10. The same process is performed about other connections used for the communication with the server 20. Therefore, information about a plurality of connections may be recorded in the connection management table 52.

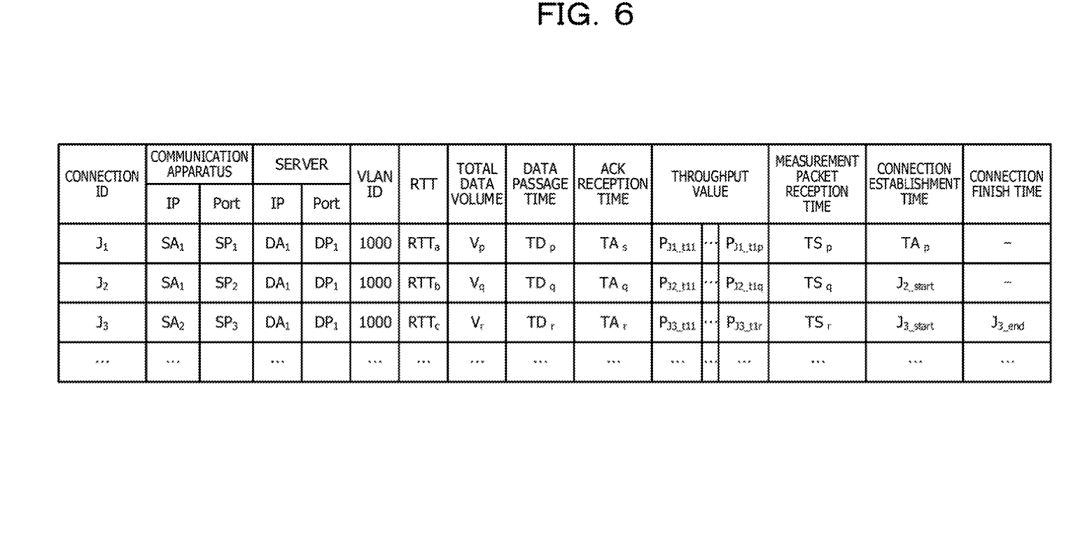

FIG. 6 illustrates an exemplary connection management table 52. Information about a plurality of connections is recorded in the connection management table 52 illustrated in FIG. 6. The connection of connection ID=J₂ is used for the communication between the communication apparatus 10 and the server 20 that are the same as those of the connection of connection ID=J₁. The connection of connection ID=J₃ is an example of connection between a communication apparatus 10 which is different from that of the connection ID=J₁, for example, and a server 20.

Although a plurality of times of throughput calculation results are stored for each connection in the example of FIG. 6, the number of throughput calculation results stored for each connection may be arbitrarily changed depending on implementation. That is, only the newest throughput may be recorded in the connection management table 52, or the number of calculation results that can be used when performing the statistical process may be stored.

Of the information in the connection management table 52, the measurement packet reception time is updated whenever the measurement apparatus 30 receives a packet of which length is smaller than a threshold transmitted to the communication apparatus 10 from the server 20. The ACK reception time is updated whenever the measurement apparatus 30 receives the ACK packet transmitted from the communication apparatus 10 to the server 20. Therefore, using a difference between the measurement packet reception time and the ACK reception time, the RTT calculation unit 42 updates RTT, and updates data in the connection management table 52 with the value of the obtained RTT.

The throughput measurement unit 43 acquires the newest RTT from the connection management table 52, and calculates throughput using the total data volume of the connection of process target, data passage time, and ACK reception time.

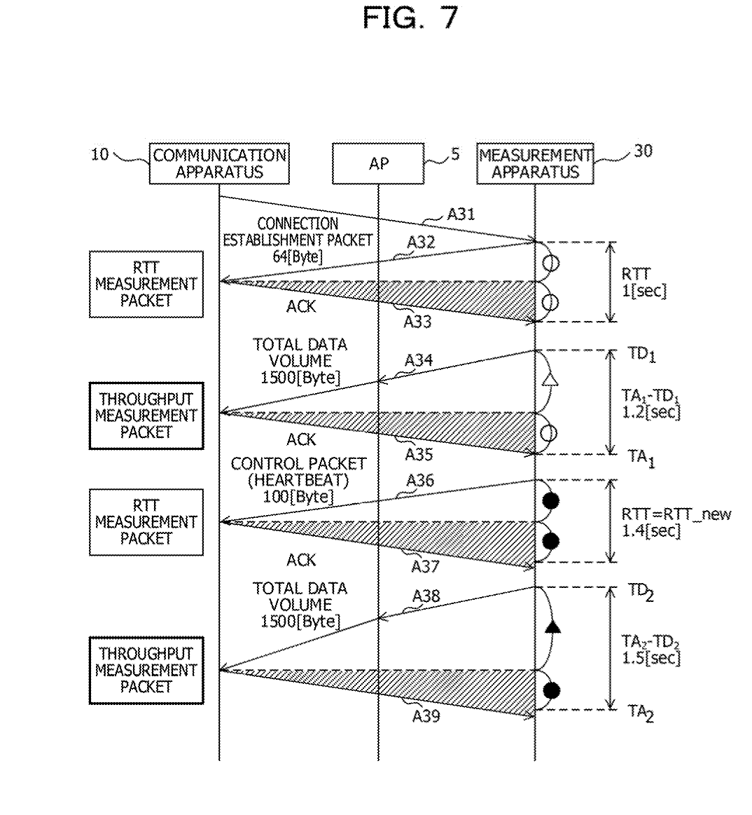

FIG. 7 illustrates an exemplary measurement method according to the first embodiment. In the example of FIG. 7, a threshold is assumed to be set to be 150 bytes. In this case, the measurement packet is a packet of less than 150 bytes. For the ease of illustration of the measurement process of RTT or throughput in FIG. 7, the measurement apparatus 30 is depicted to receive the packet from the communication apparatus 10 but, as illustrated in FIGS. 1, 5 and other figures, the communication apparatus 10 actually communicates with the server 20. That is, the measurement apparatus 30 acquires the packet transmitted and received between the communication apparatus 10 and the server 20 via the TAP 15.

When a SYN packet for establishing a connection from the communication apparatus 10 is transmitted as indicated by an arrow A31, a SYN+ACK packet is transmitted to the communication apparatus 10 from the server 20 (an arrow A32). Here, assuming that the packet length of the SYN+ACK packet is 64 bytes. Since the packet length of the SYN+ACK packet is less than a threshold, the analysis unit 41 in the measurement apparatus 30 records reception time of the SYN+ACK packet in the connection management table 52 as the reception time of the measurement packet. When the ACK packet transmitted to the server 20 from the communication apparatus 10 is input in the measurement apparatus 30, the RTT calculation unit 42 sets a difference between the reception time of the ACK packet and the reception time of the measurement packet to be RTT (an arrow A33). In FIG. 7, the RTT calculation unit 42 calculates with RTT=1 (sec).

Next, a data packet including 1500 bytes of data is assumed to be transmitted to the communication apparatus 10 from the server 20 (an arrow A34). Then, since the packet length of the data packet is greater than the threshold, the analysis unit 41 in the measurement apparatus 30 determines not to use the data packet as the measurement packet, and records time TD₁ at which the data packet is received as data passage time. When an ACK packet addressed to the server 20 is received at time TA₁, the analysis unit 41 in the measurement apparatus 30 records the time TA₁ as ACK reception time (an arrow A35). The throughput measurement unit 43 calculates time Ttr1 taken until the data packet arrives at the communication apparatus 10 from the server 20 from the equation: Ttr1=TA₁−TD₁−RTT/2=1.2−½=0.7 (sec). Then, the throughput measurement unit 43 calculates throughput (Thr1) as follows: Thr1=Vₚ/Ttr1=1500 (Byte)×8 (bit)/0.747 (kbps).

Then, 100 bytes of a heartbeat packet is assumed to be transmitted to the communication apparatus 10 from the server 20 (an arrow A36). Since the packet length of the heartbeat packet is less than a threshold, the analysis unit 41 in the measurement apparatus 30 records reception time of the heartbeat packet as reception time of the measurement packet. When an ACK packet transmitted to the server 20 from the communication apparatus 10 is input in the measurement apparatus 30, the RTT calculation unit 42 sets a difference between the reception time of the ACK packet and the reception time of the measurement packet to be RTT (an arrow A37). Assuming that the RTT calculation unit 42 calculates with RTT=1.4 (sec). The RTT calculation unit 42 updates RTT to the newest value.

A data packet including 1500 bytes of data is assumed to be transmitted to the communication apparatus 10 from the server 20 as indicated by an arrow A38. Since a packet length of the data packet is greater than a threshold, the analysis unit 41 in the measurement apparatus 30 records time TD₂ at which the data packet is received as data passage time. Then, when an ACK packet addressed to the server 20 is received at time TA₂, the analysis unit 41 in the measurement apparatus 30 records the time TA₂ as ACK reception time (an arrow A39). The throughput measurement unit 43 calculates time Ttr2 taken until the data packet arrives at the communication apparatus 10 from the server 20 from the equation: Ttr2=TA₂−TD₂−RTT/2=1.5−1.4/2=0.8 (sec). The throughput measurement unit 43 calculates throughput (Thr2) as follows. Thr2=Vₚ/Ttr2=1500 (Byte)×8 (bit)/0.8=15 (kbps).

When the process by the throughput measurement unit 43 is finished, the display data generation unit 45 generates the result display data 53 including information, such as a measurement result of throughput, a calculation result of RTT, for example. As a format of the result display data 53, any format in which an operator may recognize the measurement result may be employed. When the display data generation unit 45 outputs the result display data 53 to the display unit 60, the display unit 60 displays the result display data 53 on a screen. Then, the operator may visually check the measurement result by the measurement apparatus 30. Therefore, the operator may recognize the value of the obtained throughput and recognize whether throughput has changed suddenly, for example.

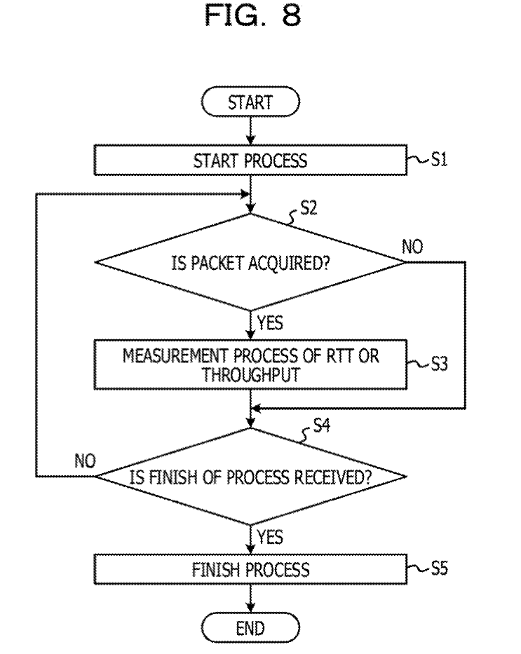

FIG. 8 is a flowchart illustrating an exemplary process performed in the measurement apparatus 30. Upon start-up of the process of a measurement process, the measurement apparatus 30 determines whether a packet is acquired (steps S1, S2). If a packet is acquired, the measurement apparatus 30 performs the measurement process of RTT or throughput (Yes in step S2, step S3). If it is determined that it is after the process of step S3, or no packet is received in step S2, the measurement apparatus 30 determines whether finish of the process is received (step S4). If finish of the process is not received, the measurement apparatus 30 returns to step S2 (No in step S4). If finish of the process is received, the measurement apparatus 30 finishes the process of the measurement process (Yes in step S4, step S5).

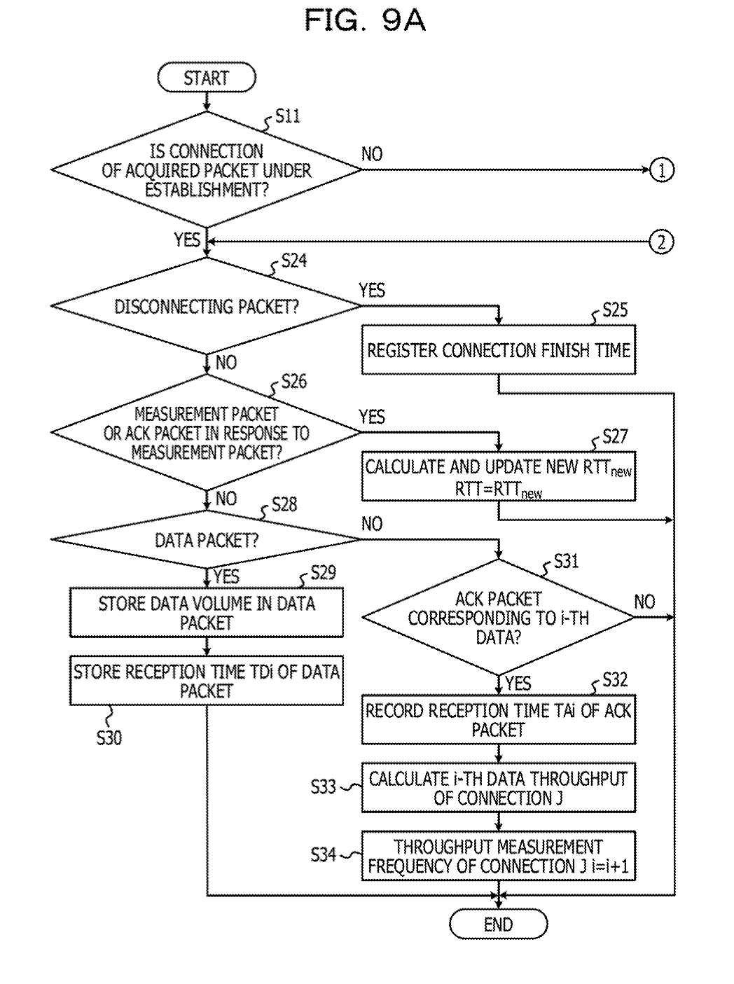

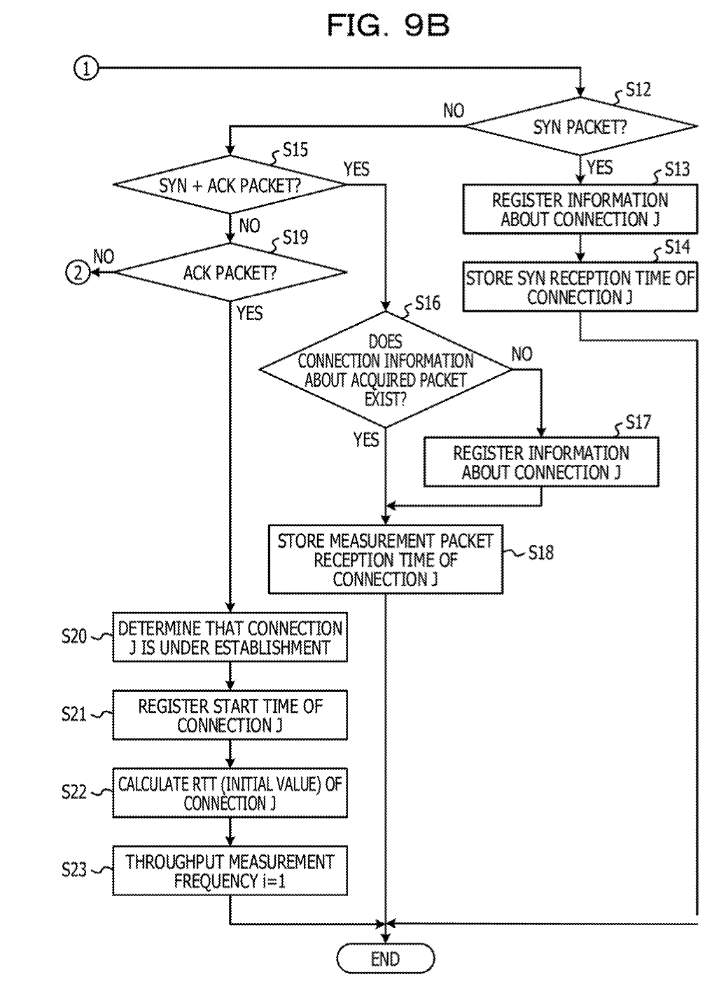

FIGS. 9A and 9B are flowcharts illustrating an example of measurement process. FIGS. 9A and 9B illustrate details of the process of step S3 of FIG. 8. In the flowcharts of FIGS. 9A and 9B, a connection of process target is referred to as a connection J. Measurement frequency of throughput is stored as i. In the example of FIGS. 9A and 9B, a case where a single ACK packet is transmitted in response to a single data packet is described. Therefore, the measurement frequency i of throughput also represents the number of data packets transmitted to the communication apparatus 10 via a connection of process target. In the exemplary process of FIGS. 9A and 9B, the analysis unit 41 regards a packet used for establishment of a connection as a target used for calculation of RTT without checking the packet length. FIGS. 9A and 9B are illustrative only, and the process may be changed depending on implementation. For example, the process of step S14 may be omitted.

The analysis unit 41 determines whether the connection of the packet acquired via the reception unit 32 is under establishment with reference to the connection management table 52 (step S11). If the connection of the acquired packet is not established, the analysis unit 41 determines whether the packet of process target is a SYN packet (No in step S11, step S12). If the packet of process target is a SYN packet, the analysis unit 41 registers information about the connection J used for the transmission and reception of the packet of process target in the connection management table 52 (Yes in step S12, step S13). The analysis unit 41 stores SYN reception time of the connection J (step S14).

If the packet of process target is not a SYN packet, the analysis unit 41 determines whether the packet of process target is a SYN+ACK packet (No in step S12, step S15). If the packet of process target is a SYN+ACK packet, the analysis unit 41 determines whether information about the connection J used for transmission and reception of the acquired packet is recorded in the connection management table 52 (Yes in step S15, step S16). If the information about the connection J is not recorded, the analysis unit 41 registers information about the connection J in the connection management table 52 (No in step S16, step S17). If the information about the connection J is registered in the connection management table 52 or after registration of the information about the connection J, the analysis unit 41 records measurement packet reception time of the connection J (Yes in step S16, step S18).

If the packet of process target is not a SYN+ACK packet, the analysis unit 41 determines whether the packet of process target is an ACK packet (No in step S15, step S19). If the packet of process target is an ACK packet, the analysis unit 41 determines that the connection J is under establishment (Yes in step S19, step S20). The analysis unit 41 registers start time of the connection J in the connection management table 52 (step S21). The RTT calculation unit 42 calculates an initial value of RTT of the connection J using the information in the connection management table 52 (step S22). The RTT calculation unit 42 sets the measurement frequency i of throughput about the connection J to be 1 (step S23).

If it is determined that the packet of process target is not the ACK packet in step S19, and it is determined that a connection is under establishment in step S11, processes after step S24 are performed. The analysis unit 41 determines whether the packet of process target is a disconnecting packet (step S24). If the packet of process target is a disconnecting packet, the analysis unit 41 registers connection finish time about the connection J, and finishes the process (Yes in step S24, step S25).

If the packet of process target is not a disconnecting packet, the analysis unit 41 determines whether the packet of process target is either of a measurement packet or an ACK packet in response to the measurement packet (No in step S24, step S26). If the packet of process target is a measurement packet or an ACK packet in response to the measurement packet, the analysis unit 41 and the RTT calculation unit 42 calculate a new RTT (RTT_{new}), and update a value of RTT (Yes in step S26, step S27).

If the packet of process target is neither the measurement packet nor the ACK packet in response to the measurement packet, the analysis unit 41 determines whether the packet of process target is a data packet (No in step S26, step S28). If the packet of process target is a data packet, the analysis unit 41 records a data volume in the data packet and reception time TD; of the data packet in the connection management table 52 (Yes in step S28, steps S29, S30).

If the packet of process target is not a data packet, the analysis unit 41 determines whether the packet of process target is an ACK packet in response to an i-th data packet (No in step S28, step S31). If the packet of process target is not an ACK packet in response to the i-th data packet, the analysis unit 41 finishes the process (No in step S31).

If the packet of process target is an ACK packet in response to the i-th data packet, the analysis unit 41 records reception time TA; of the ACK packet in the connection management table 52 (Yes in step S31, step S32). The throughput measurement unit 43 calculates i-th throughput of the connection J (step S33). The throughput measurement unit 43 increments throughput measurement frequency of the connection J by 1, and finishes the process (step S34).

For the ease of description, a case where a single ACK packet is transmitted in response to a single data packet is described as an example in the description above, but transmission frequency of the ACK packet may be one in response to a plurality of data packets. In this case, for example, a process to determine a transmission order of the data packet among the data packets of which data receiving condition are notified by the i-th ACK packet is included before the process of the step S29 of FIG. 9A. The processes of steps S29 and S30 are performed to the data packet transmitted first among the data packets of which receiving conditions are notified by the i-th ACK packet. Regarding the data packet transmitted second or thereafter among the data packets of which receiving conditions are notified by the i-th ACK packet, the analysis unit 41 adds the data volume in the packet of process target to the transmitted data amount of the connection J. The analysis unit 41 does not update the reception time of the data packet. Therefore, the value of TDᵢ is still the transmission time of the first packet among the packets of which receiving condition of data is notified by the i-th ACK packet. Other processes are the same as those of the case where a single ACK packet is transmitted in response to a single data packet.

As described above, in the method according to the first embodiment, throughput is calculated using the newest RTT obtained using the packet of which packet length is less than a threshold. Therefore, throughput is calculated precisely. The operator may recognize the measurement result by monitoring the screen of the display unit 60. Therefore, when throughput and RTT change largely, for example, the operator may determine whether to respond to the change.

### Second Embodiment

The measurement apparatus 30 may also obtain an average value of throughput obtained for each connection. In the average throughput, since an influence of a momentary change of a radio wave condition in a wireless section becomes small, a tendency of a temporal change of throughput is easily known.

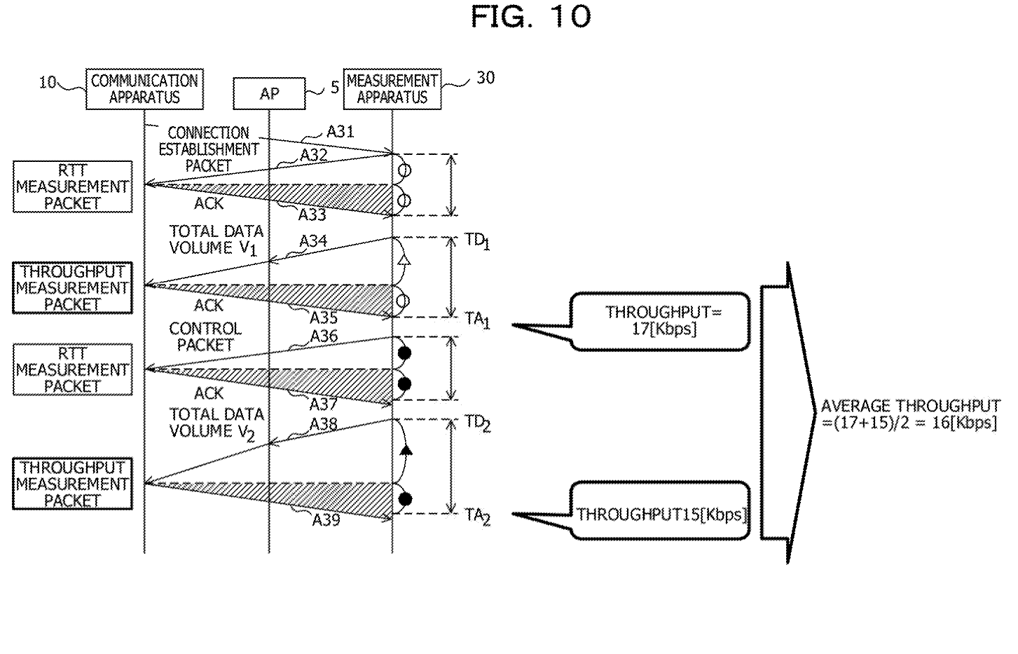

FIG. 10 illustrates an exemplary measurement method according to a second embodiment. FIG. 10 describes a process performed when obtaining average throughput with reference to the communication described in FIG. 7 as an example. Arrows A31 to A39 in FIG. 10 are the same as those of arrows A31 to A39 described with reference to FIG. 7. Processes of the analysis unit 41, the RTT calculation unit 42, and the throughput measurement unit 43 in the second embodiment are the same as those of the first embodiment. Assuming that throughput of data is 17 kbps at the time of the arrows A34 and A35 and throughput of data is 15 kbps at the time of arrows A38 and A39.

A statistical processing unit 44 obtains a calculation result of throughput obtained during a period in which average throughput is obtained about a connection of process target and calculates an average value. In the example of FIG. 10, the average throughput in the period from the arrow A34 to the arrow A39 is a calculation target, and the statistical processing unit 44 calculates with an average value being 16 kbps.

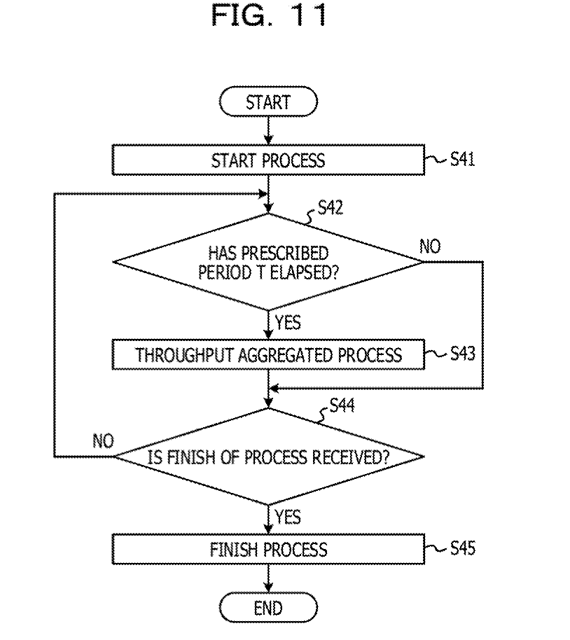

FIG. 11 is a flowchart illustrating an exemplary process performed in the measurement apparatus. In the example of FIG. 11, average throughput of each connection is obtained for every prescribed period T. Upon start-up of a process of a throughput aggregated process, the measurement apparatus 30 determines whether a prescribed period T has elapsed (steps S41, S42). In the following description, the terms “aggregation” and “aggregated process” refer to generating one or more pieces of statistical information using information about obtained throughput. When the prescribed period T elapses, the measurement apparatus 30 performs an aggregated process of the obtained throughput in the prescribed period T (Yes in step S42, step S43). If it is determined that it is after the process of step S43 or the prescribed period T has not elapsed in step S42, the measurement apparatus 30 determines whether finish of the process is received (step S44). If finish of the process is not received, the measurement apparatus 30 returns to step S42 (No in step S44). Thereafter, the measurement apparatus 30 performs the process after step S43 when the prescribed period T elapses after the previous aggregated process is performed. If finish of the process is received, the measurement apparatus 30 finishes the process of the aggregated process (Yes in step S44, step S45).

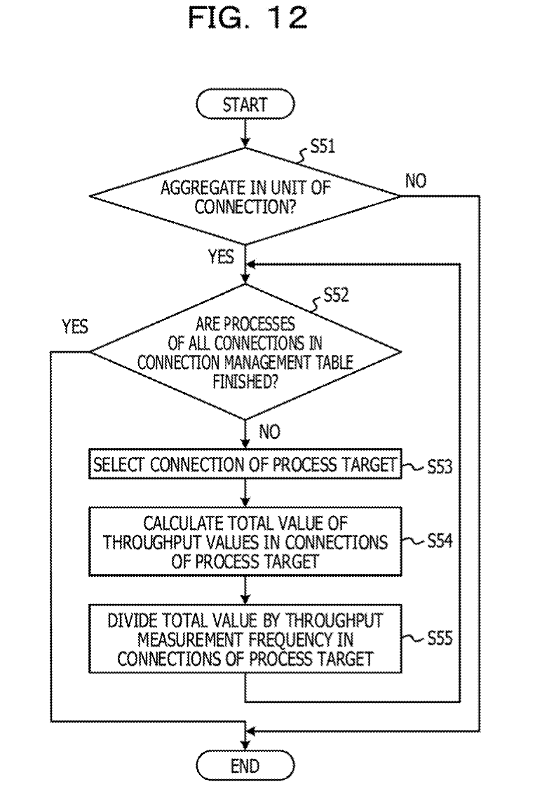

FIG. 12 is a flowchart illustrating an exemplary aggregated process. FIG. 12 illustrates details of the process of step S43 of FIG. 11. In a period of throughput aggregation, the statistical processing unit 44 determines whether the obtained throughput is to be aggregated in a unit of connection (step S51). If the throughput is not to be aggregated in a unit of connection, the statistical processing unit 44 finishes the process (No in step S51).

If the throughput is to be aggregated in a unit of connection, the statistical processing unit 44 determines whether the processes about all the connections in the connection management table 52 are finished (Yes in step S51, step S52). If the processes about all the connections in the connection management table 52 are not finished, the statistical processing unit 44 selects a connection of process target from among unprocessed connections (No in step S52, step S53). The statistical processing unit 44 calculates a total value of the throughput values obtained in the prescribed period T in the connection of process target (step S54). The statistical processing unit 44 divides the total value by the throughput measurement frequency performed in the prescribed period T in the connection of process target, and returns to step S52 (step S55). If it is determined in step S52 that the processes about all the connections in the connection management table 52 are finished, the statistical processing unit 44 finishes the process (Yes in step S52).

When the process by the statistical processing unit 44 is finished, the display data generation unit 45 generates the result display data 53 including information, such as an average value of throughput. Since the result display data 53 is output to the display unit 60, the operator may visually check the measurement result of the throughput and may recognize whether the throughput has changed suddenly, for example, as in the first embodiment.

### Third Embodiment

In a third embodiment, the measurement apparatus 30 performs a statistical process of throughput values obtained in a plurality of connections for each access point 5. Therefore, an index value indicating a communication state at that access point 5 is calculated for each access point 5.

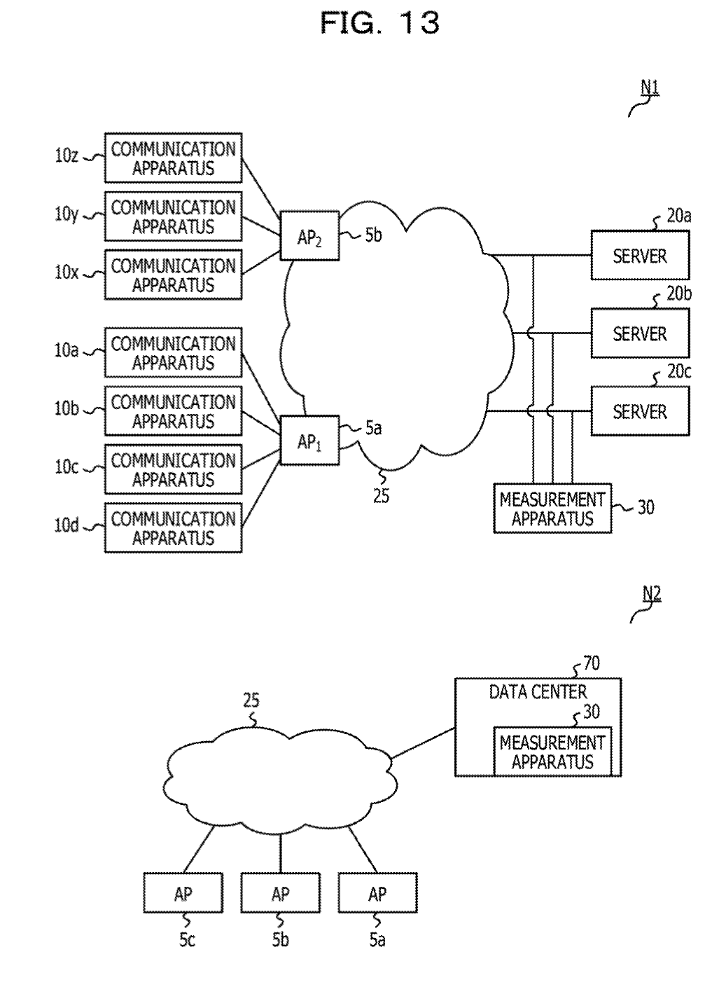

FIG. 13 illustrates an exemplary network. Each network is illustrative only and the number of the servers 20 and the access points 5 may be changed depending on implementation. The number of the communication apparatuses 10 connected with the access points 5 may be determined arbitrarily. In any of the networks illustrated in FIG. 13, a change in the throughput in a wired communication section and a difference in the throughputs among a plurality of wired communication sections are negligible compared with a difference in the throughputs in a wireless section.

In a network N1, servers 20a to 20c are connected with a network 25. Access points 5a and 5b are included in the network 25. The measurement apparatus 30 here is connected with each of the servers 20a to 20c not via the network 25. The measurement apparatus 30 here is connected with a position at which time for communication between the server 20 and the measurement apparatus 30 is negligible via a TAP 15 (not illustrated) in the same manner as in the first and the second embodiments.

Communication apparatuses 10a to 10d connect with the access point 5a, and communication apparatuses 10x to 10z connect with the access point 5b. Each communication apparatus 10 communicates using an IP address assigned by the access point 5 of connection destination. A range of the IP address to be assigned to the communication apparatus 10 of connection destination by each access point 5 here is determined in advance.

In a network N2, a plurality of servers 20 are included in a data center 70, and the measurement apparatus 30 is also included in the data center 70. In the network N2, the measurement apparatus 30 is assumed to be connected, in the data center 70, with each of the servers 20 via the TAP 15 in the data center 70, and may measure throughput in communication of each server 20. The data center 70 is connected with the network 25. Access points 5a to 5c are included in the network 25. Although no communication apparatus 10 is illustrated in the network N2, an arbitrary number of communication apparatuses 10 are connected with the access points 5 also in the network N2 and perform communication using IP addresses assigned by the access points 5.

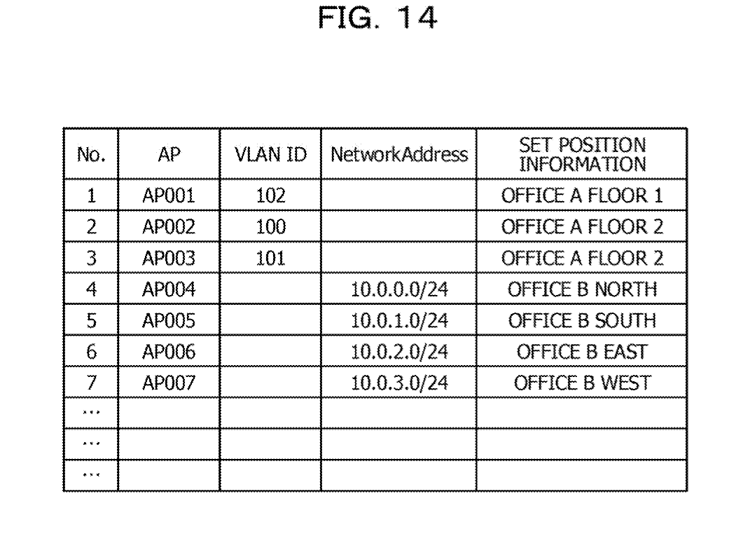

FIG. 14 illustrates an exemplary network (NW) information table 54. The measurement apparatus 30 according to the third embodiment includes the NW information table 54. The statistical processing unit 44 specifies a range in which the statistical process of throughput is to be performed using the NW information table 54.

In the example of FIG. 14, the NW information table 54 includes entry numbers, identification information of access points (AP), VLAN IDs, network addresses, and set position information. In the NW information table 54, identification information and set position information of the access point 5 are registered for each access point 5, but one of the VLAN ID and the network address does not necessarily have to be registered for all the access points 5.

In the example of FIG. 14, a different VLAN ID is correlated with each access point 5. The access point 5 identified by AP001 is used for the communication with VLAN ID=102. Therefore, an average value of throughput of communication via the access point 5 identified by AP001 may be obtained by obtaining an average value of throughput measurement results of packets including VLAN ID=102 in the statistical processing unit 44. Similarly, the access point 5 identified by AP002 is used for communication with VLAN ID=100, and the access point 5 identified by AP003 is used for communication with VLAN ID=101. Therefore, an average value of throughput via each access point 5 may be obtained by obtaining an average value of throughput for each value specified by each VLAN ID.

Also about the network address, a different value is assigned to each access point 5 for which communication state is to be checked. Each access point 5 assigns IP addresses included in a range of a designated network address to the communication apparatuses 10 connected with the access point 5. For example, an access point 5 identified by AP004 assigns IP addresses corresponding to 10.0.0.0/24 to communication apparatuses 10 connected with the access point 5 identified by AP004. Therefore, a subnetwork having the network addresses of 10.0.0.0/24 is generated by the access point 5 identified by AP004. Similarly, an access point 5 identified by AP005 assigns IP addresses of 10.0.1.0/24, and an access point 5 identified by AP006 assigns IP addresses of 10.0.2.0/24 to the communication apparatuses 10. An access point 5 identified by AP007 assigns IP addresses of 10.0.2.0/24 to the communication apparatuses 10. Therefore, each subnetwork specified by network addresses set in the NW information table 54 is generated by each access point 5.

Then, the statistical processing unit 44 obtains an average value of measured throughput for each subnetwork and for each VLAN ID. A set position of each access point 5 is recorded in the NW information table 54. For example, the access point 5 of AP001 is set in a floor 1 of an office A, and the access points 5 of AP002 and AP003 are set in a floor 2 of the office A. AP004 is set on the north side of an office B, AP005 is set on the south side of the office B, AP006 is set on the east side of the office B, and AP007 is set on the west side of the office B. The display data generation unit 45 may generate the result display data 53 when generating display data, so that set position information in the NW information table 54 may be suitably displayed with an aggregation result of throughput and identification information of the access point 5.

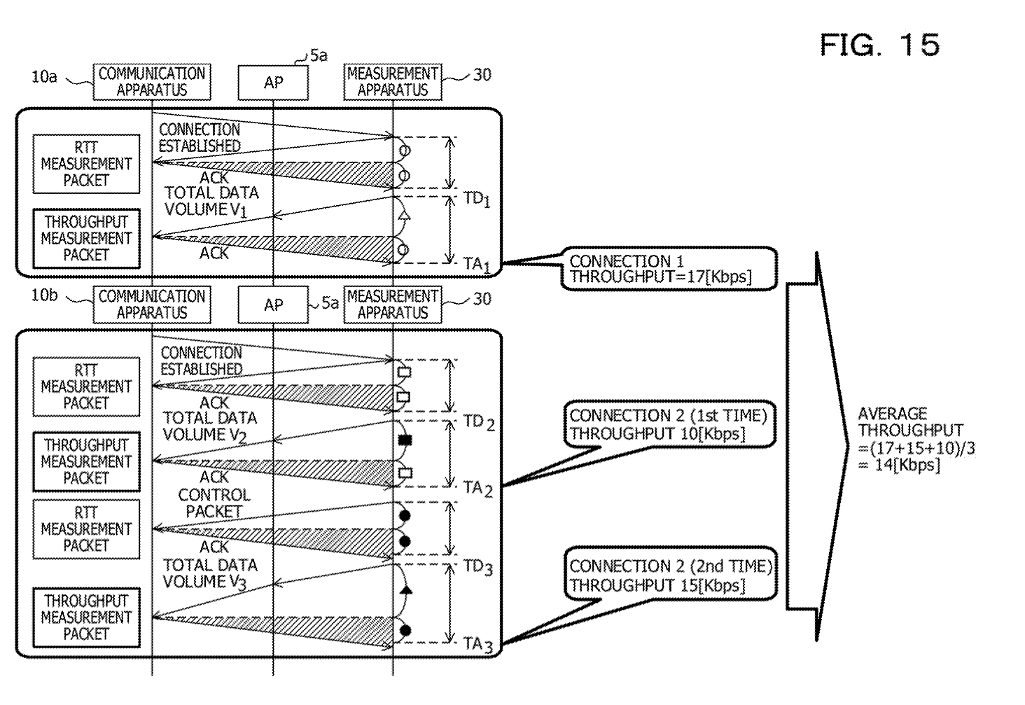

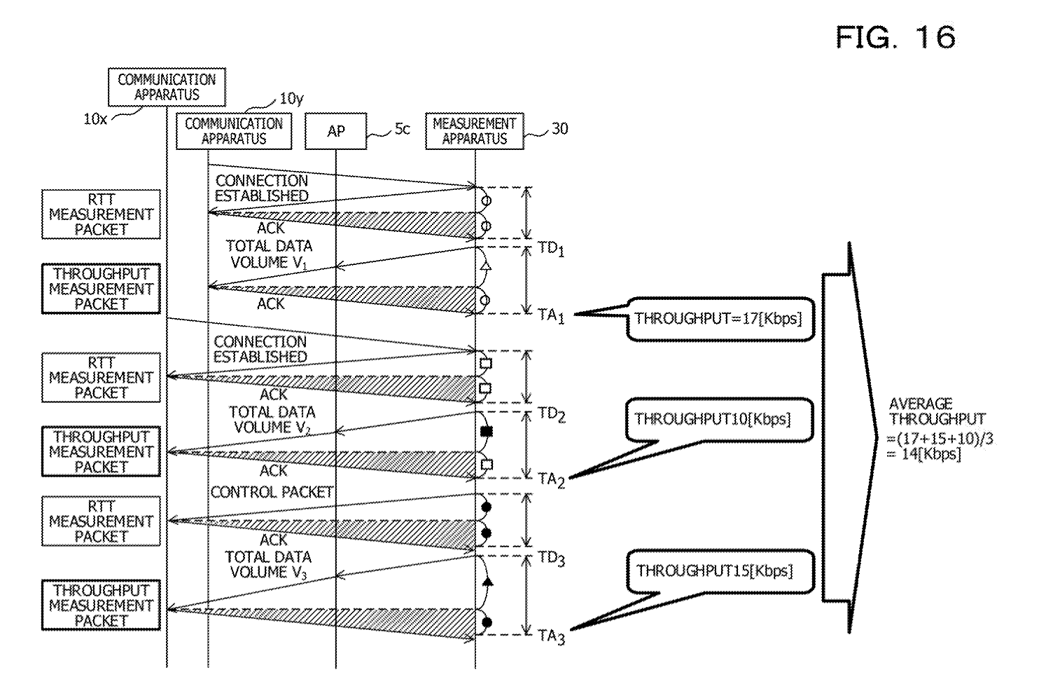

Hereinafter, an example in which a statistical process of the throughput is performed for each subnetwork will be described with reference to FIG. 15, and an example in which a statistical process of the throughput is performed for each VLAN ID will be described with reference to FIG. 16.

FIG. 15 illustrates an exemplary aggregated process. In FIG. 15, both a communication apparatus 10a and a communication apparatus 10b are assumed to be connected with the access point 5a. Identification information of the access point 5a here is AP004. Therefore, the communication apparatus 10a and the communication apparatus 10b are included in the subnetwork of 10.0.0.0/24. A connection between the communication apparatus 10a and the access point 5a is referred to as a connection 1, and a connection between the communication apparatus 10b and the access point 5a is referred to as a connection 2.

Throughput is calculated about each connection by performing the same process as in the first embodiment. Here, throughput is measured once in the connection 1 and measured twice in the connection 2 during the prescribed period T.

At the time of aggregation, the statistical processing unit 44 obtains an average value of throughput obtained in each subnetwork during the period T. As illustrated in FIG. 15, throughput=17 kbps is assumed to be obtained in the connection 1. Further, throughput=10 kbps and 15 kbps are assumed to be obtained in the connection 2. The statistical processing unit 44 averages these values and obtains an average value of the throughput between the access point 5a which form the subnetwork of 10.0.0.0/24 and the communication apparatuses 10. In the example of FIG. 15, since the average of 17 kbps, 10 kbps, and 15 kbps is obtained as the average throughput at 10.0.0.0/24, the average throughput is 14 kbps.

In FIG. 15, the throughput is averaged for each subnetwork, and one subnetwork is generated for each access point 5 with which the communication apparatuses 10 are connected. Therefore, if an averaging process of the throughput is performed for each subnetwork, throughput in one or more communication apparatuses 10 communicating via a specific access point 5 will be averaged. The communication destination of each communication apparatus 10 in the subnetwork may be the same or different.

For example, the communication apparatuses 10a to 10d are included in the subnetwork generated by the access point 5a of the network N1 of FIG. 13. Each of the communication apparatuses 10 in the subnetwork generated by the access point 5a may communicate with the servers 20a to 20c via the network 25. Therefore, with the process of the throughput in the subnetwork generated at the access point 5a, throughput in communication between the communication apparatus 10a and the server 20a and throughput in communication between the communication apparatus 10b and the server 20c may be aggregated. Further, a single communication apparatus 10 may communicate with a plurality of servers 20 at the same time. For example, when the communication apparatus 10a communicates with the server 20b and the server 20c at the same time, throughputs obtained in these communications may be aggregated. Therefore, an average value of the throughput obtained in the statistical process is an index value of communication quality via the access point 5 which generates the subnetwork for which the statistical process is performed.

FIG. 16 illustrates an example of aggregated process using a VLAN ID. In FIG. 16, a communication apparatus 10x and a communication apparatus 10y are assumed to be connected with an access point 5c. Identification information of the access point 5c here is AP002. Therefore, the communication apparatus 10x and the communication apparatus 10y are included in the VLAN of VLAN ID=100.

Also in the case of FIG. 16, calculation of throughput is performed in the same manner as in the first embodiment. At the time of statistical process, the statistical processing unit 44 obtains an average value of throughput obtained in each VLAN during the prescribed period T. In the case of VLAN of VLAN ID=100, as illustrated in FIG. 16, throughput=17 kbps, 10 kbps, and 15 kbps are assumed to be obtained during the period T. The statistical processing unit 44 averages these values and obtains an average of throughput between the access point 5 which forms VLAN of VLAN ID=100 and the communication apparatus 10. In the example of FIG. 16, the average throughput in VLAN of VLAN ID=100 is 14 kbps.

In a case where the statistical process for each VLAN ID is performed, as in the statistical process for each subnetwork, the throughput obtained by the communication among a plurality of combinations of the communication apparatuses 10 and the servers 20 may be aggregated. Therefore, also in the statistical process for each VLAN ID, an average value of throughput may be considered as an index value of communication quality via the access point 5 included in the VLAN for which the statistical process is performed.

Thus, when an average value of throughput is obtained in a unit of VLAN or subnetwork, an average value of the measurement result obtained in a unit of VLAN or subnetwork is displayed on the display unit 60 as the result display data 53. Therefore, the operator may easily specify the access point 5 at which communication rate becomes slower due to a failure in the access point 5, concentration of access, for example. By using the set position information in the NW information table 54, the operator may easily specify the set position of the access point 5 at which communication rate becomes slower.

### Fourth Embodiment

The display data generation unit 45 may include a temporal change of information obtained in the first to the third embodiments in the result display data 53.

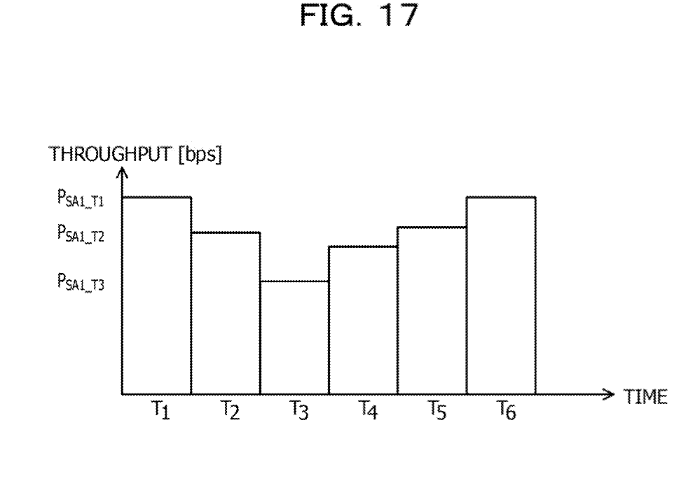

FIG. 17 illustrates an exemplary variation in throughput. The example of FIG. 17 illustrates, as illustrated in FIG. 15, an example of result display data 53 in a case where throughput is averaged for each period T in a unit of subnetwork on the side of the communication apparatus 10 and a change in the throughput is illustrated in time series. In a period T₁, an average of the throughput obtained in the subnetwork of process target is P_{SA1}_{_}_{T1}. An average of the throughput obtained in the subnetwork of process target is lowered to P_{SA1}_{_}_{T2} in a period T₂, and is lowered to P_{SA1}_{_}_{T3} in a period T₃. When such a temporal change in the throughput is displayed on the display unit 60, the operator may perform measures to avoid reduction of the throughput.

After performing measures against reduction of the throughput, the operator may check a temporal change in the throughput displayed on the screen of the display unit 60 to check effects of the measures. In the example of FIG. 17, the average of the throughput obtained in the subnetwork of process target begins to increase in a period T₄ and recovers to P_{SA1}_{_}_{T1} in a period T₆. As illustrated in FIG. 17, the operator may check that the effects of the measures have been found by checking that the throughput has increased in the periods T₄ to T₆ after the period T₃ in which the measures are taken.

Thus, since the result display data 53 indicating the temporal change in the average value of throughput is displayed on the display unit 60, the operator may monitor the change in the throughput in time series for each access point 5. Therefore, the operator may detect network abnormality or failure early and respond to the detected abnormality or failure early. Although a case where an average value of throughput is obtained in a unit of network address to check a temporal change for each subnetwork is described in the example of FIG. 17, a temporal change in an average value in a unit of VLAN may also be obtained.

### Fifth Embodiment

By performing a comparison process of distribution of communication quality of the communication apparatuses 10 in a unit of VLAN or subnetwork, communication quality among a plurality of VLANs and a plurality of subnetworks may be compared, for example.

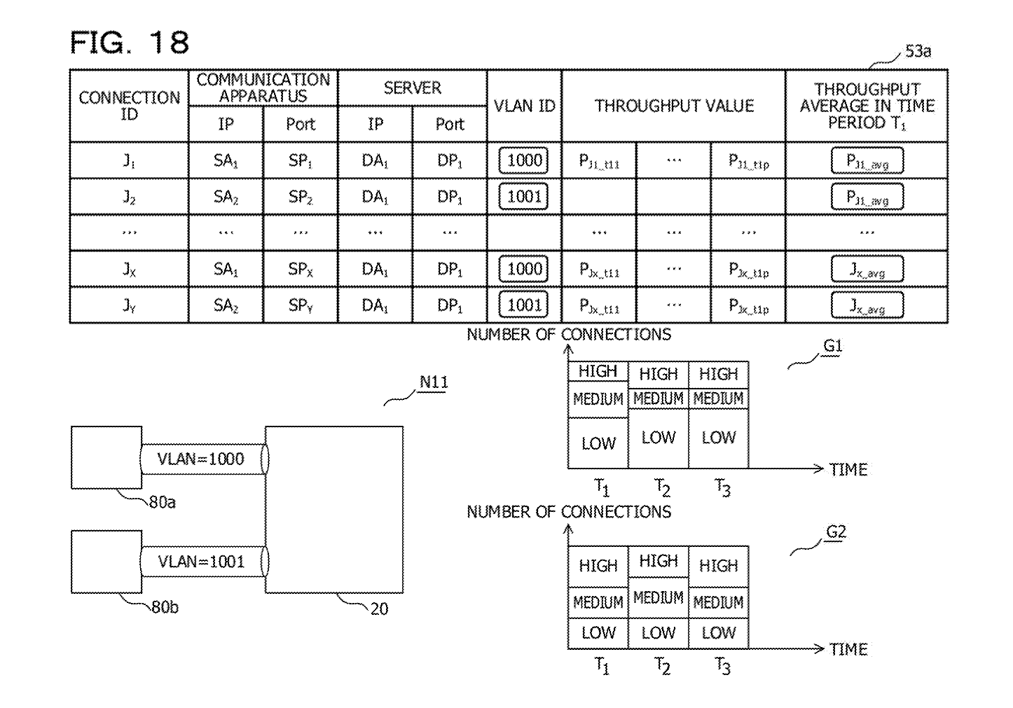

FIG. 18 illustrates an exemplary comparison process of communication quality. A network N11 is an example in which communication apparatus groups 80 (80a, 80b) are connected with the server 20 via VLANs. Each of the communication apparatuses 10 included in the communication apparatus group 80a communicates with the server 20 using VLAN of VLAN ID=1000. Each of the communication apparatuses 10 included in the communication apparatus group 80b communicates with the server 20 using VLAN of VLAN ID=1001.

A measurement method of throughput between each of the communication apparatuses 10 and the server 20 is the same as that of the first embodiment. The statistical processing unit 44 obtains an average value of throughput about each connection in each prescribed period. The display data generation unit 45 includes information obtained for each communication apparatus 10 in the result display data 53. In the example of result display data 53a, connection IDs, IP addresses and port numbers of the communication apparatuses 10, IP addresses of and port numbers of the servers 20, VLAN IDs, throughput values, and average values of throughput in the latest period are included about each connection.

Further, the display data generation unit 45 classifies the throughput into a plurality of levels, and then obtains the number of communication apparatuses 10 in each level. For example, assuming that the display data generation unit 45 classifies the throughput into three levels of high, medium, and low:

high: throughput≧20 Mbps

medium: 20 Mbps>throughput≧10 Mbps

low: 10 Mbps>throughput.

The display data generation unit 45 counts the number of the communication apparatuses 10 classified into each level for each VLAN ID.

Since the statistical processing unit 44 calculates the average value of throughput periodically also thereafter, the connection management table 52 updates the result display data 53 using the average of the newly obtained throughput for each process of the statistical processing unit 44. At the same time with the update of the result display data 53, the statistical processing unit 44 counts distribution for each level of the throughput of the communication apparatus 10 about each VLAN.

The display data generation unit 45 makes graphs the distribution of each level of the throughput in each period for each VLAN based on the result of the count. For example, a graph G1 is assumed to be obtained about the VLAN of VLAN ID=1000. When the graph G1 is displayed on the display unit 60, the operator may analyze using the graph G1. For example, the operator may analyze that the number of communication apparatuses 10 with high throughput increases whereas the number of communication apparatuses 10 with low throughput also increases, and the number of communication apparatuses 10 with medium throughput decreases in the VLAN of VLAN ID=1000 after the period T₁.

A graph G2 is assumed to be obtained about the VLAN of VLAN ID=1001. Also in this case, the operator analyzes the communication state in the VLAN using the graph G2. For example, the operator analyzes that the number of communication apparatuses 10 with high throughput and medium throughput vary whereas the number of communication apparatuses 10 with low throughput does not vary in the VLAN of VLAN ID=1001 after the period T₁.

When both the graph G1 and the graph G2 are displayed on the display unit 60, the operator may compare the communication states of the VLANs. If the communication state in one of the VLANs is worse than the other, for example, the operator may perform a process to improve the communication state in the VLAN in which communication state is relatively bad.

Thus, according to the fifth embodiment, the operator easily know the communication state in a unit of VLAN. Therefore, also in the fifth embodiment, the operator easily detects network abnormality or failure early and respond to the detected abnormality or failure early.

### Sixth Embodiment

The measurement apparatus 30 may specify a user's movement state suitably by acquiring a connection state at an access point 5 from the access point 5. In this case, even if throughput in the communication apparatus 10 is reduced, the measurement apparatus 30 may provide an operator with information for determining the cause of the reduction in the throughput, that is, due to a movement of the user or due to a problem of a network.

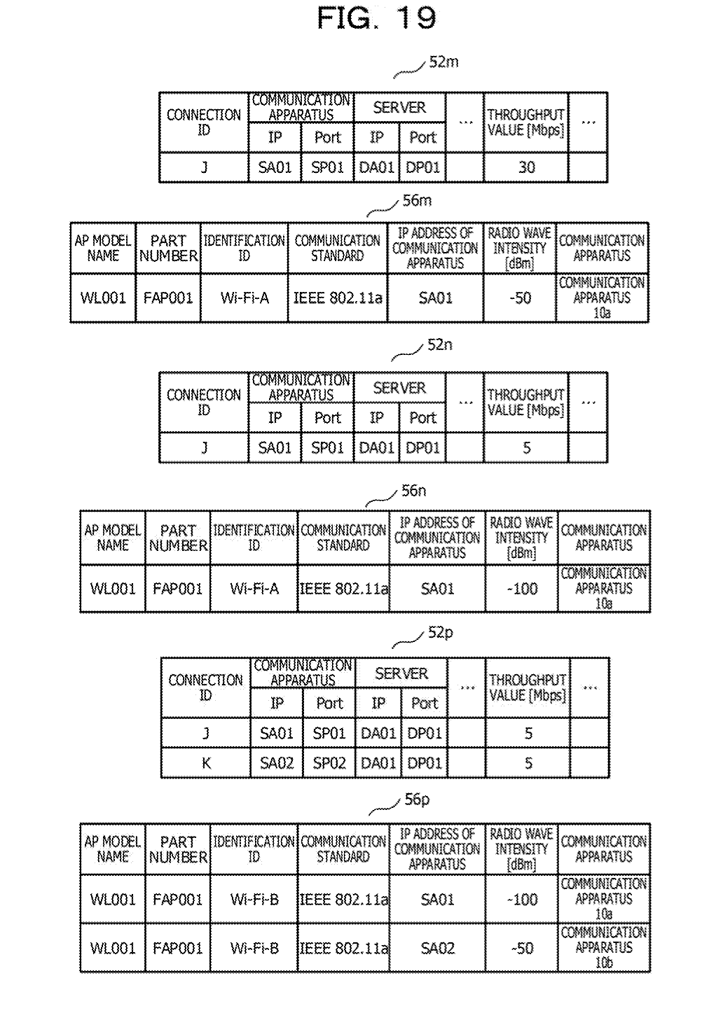

FIG. 19 illustrates exemplary information indicating a relationship between movement of a user and throughput. Throughput and RTT between the communication apparatus 10 and the server 20 are obtained in the same manner as in the first embodiment. The obtained information, such as the throughput, is recorded in the connection management table 52 for each connection. Information shown in the connection management table 52m is assumed to be obtained at time Tm.

In a sixth embodiment, the measurement apparatus 30 may acquire information, such as identification information of the communication apparatus 10 currently connected with the access point 5, intensity of a radio wave that the communication apparatus 10 receives from the access point 5, for example, by communicating with the access point 5. The communication apparatus 10 here periodically notifies receiving intensity of the radio wave to the access point 5 of connection destination. The access point 5 notifies the communication apparatus 10 being connected therewith and radio wave intensity in the communication apparatus 10 to the measurement apparatus 30 together with information about the access point.

When the analysis unit 41 acquires information about the access point 5 via the reception unit 32, the measurement apparatus 30 stores the acquired information in the memory unit 50 as access point information 56. The measurement apparatus 30 is assumed to hold access point information 56m at time Tm. In the access point information 56m, a model name, a part number, an identification ID, and a communication standard of the access point are recorded as information about the access point 5. Further, an IP address, received radio wave intensity in the communication apparatus 10, and identification information of the communication apparatus 10 are recorded as information about the communication apparatus 10 connected with the access point 5. In the example of the access point information 56m, the model of Wi-Fi-A of the access point 5 is WL001, and the part number is FAP001. The access point 5 of identification ID=Wi-Fi-A performs communication in accordance with the standard of IEEE802.11a. The communication apparatus 10a is connected with the access point 5 of identification ID=Wi-Fi-A. The IP address is SA01 and radio wave intensity of the communication apparatus 10a is −50 dBm of the communication apparatus 10a.

In the sixth embodiment, the result display data 53 includes information included in the connection management table 52 and the access point information 56. Therefore, the operator may recognize that the received radio wave intensity is −50 dBm and the throughput value is 30 Mbps in the communication apparatus 10 (the communication apparatus 10a) of the IP address=SA01 from the display of the measurement result at time Tm.

Then, since the user of the communication apparatus 10a moves away from the access point 5, the throughput is assumed to become 5 Mbps and the received radio wave intensity is assumed to become −100 dBm in the communication apparatus 10a at time Tn. Then, the connection management table 52m is changed as illustrated in the connection management table 52n. Similarly, the access point information 56m is changed as illustrated in access point information 56n. Since the information is displayed on the display unit 60, the operator recognizes that the throughput value is reducing to 5 Mbps from 30 Mbps in the communication apparatus 10 (the communication apparatus 10a) of IP address=SA01 from the measurement result at time Tm and the measurement result at time Tn. Further, the operator may check that the received radio wave intensity is reducing to −100 dBm from −50 dBm with the reduction in the throughput value from the display in the display unit 60. Then, the operator may determine that the reduction in the throughput in the communication apparatus 10a is caused by a movement of the communication apparatus 10a, for example, and determine not to take measures to improve the throughput immediately but to observe the progress.

The communication apparatus 10a is assumed to continue to move and make a handover to an access point 5 of identification ID=Wi-Fi-B from the access point 5 of identification ID=Wi-Fi-A at time Tp. Further, around the handover of the communication apparatus 10a, the communication apparatus 10b is assumed to be connected with the access point 5 of identification ID=Wi-Fi-B. Here, a connection management table 52p is assumed to be obtained as a measurement result of throughput. Information obtained from the access point 5 of identification ID=Wi-Fi-B is shown in access point information 56p.

Since the information is displayed on the display unit 60, the operator recognizes that the throughput value after the handover is 5 Mbps, and the received radio wave intensity is −100 dBm in the communication apparatus 10 (the communication apparatus 10a) of IP address=SA01 from the measurement result at time Tp. Further, the operator may also recognize that the throughput value is 5 Mbps and the received radio wave intensity is −50 dBm in the communication apparatus 10 (the communication apparatus 10b) of IP address=SA02. Then, since the throughput is 5 Mbps in both the communication apparatus 10a and the communication apparatus 10b which are different in received radio wave intensity, the operator may determine that a radio wave interference may be occurring between the communication apparatus 10a and the communication apparatus 10b. Also in this case, the operator may determine that it is possible that a cause of the relatively low throughput value is the positions of the communication apparatuses 10, an interference between the communication apparatuses 10, for example, and determine not to take measures to improve the throughput immediately.

As described above, in the sixth embodiment, not only the change in the throughput but the change in received radio wave intensity in the communication apparatuses 10 is displayed on the display unit 60 together with the change in the throughput. Therefore, even if the throughput is reduced accompanying with a decrease in the received radio wave intensity in the communication apparatus 10, the operator may determine that the possibility of occurrence of a network failure is low. Therefore, a situation in which the operator has to search a network failure, for example, whereas the throughput of the communication apparatus 10 reduces due to other causes than a network factor may be easily avoided.

### Other Embodiments

Embodiments are not limited to those described above and may be changed in various way. Some of the examples will be described.

The measurement apparatus 30 may be incorporated in the server 20. One of the information processing apparatuses in the data center in which a plurality of servers 20 are included may operate as the measurement apparatus 30.

In the above description, a packet used for the measurement of RTT is determined using a packet length of each packet, a predetermined type of packet may be specified as a packet for the measurement of RTT depending on implementation.

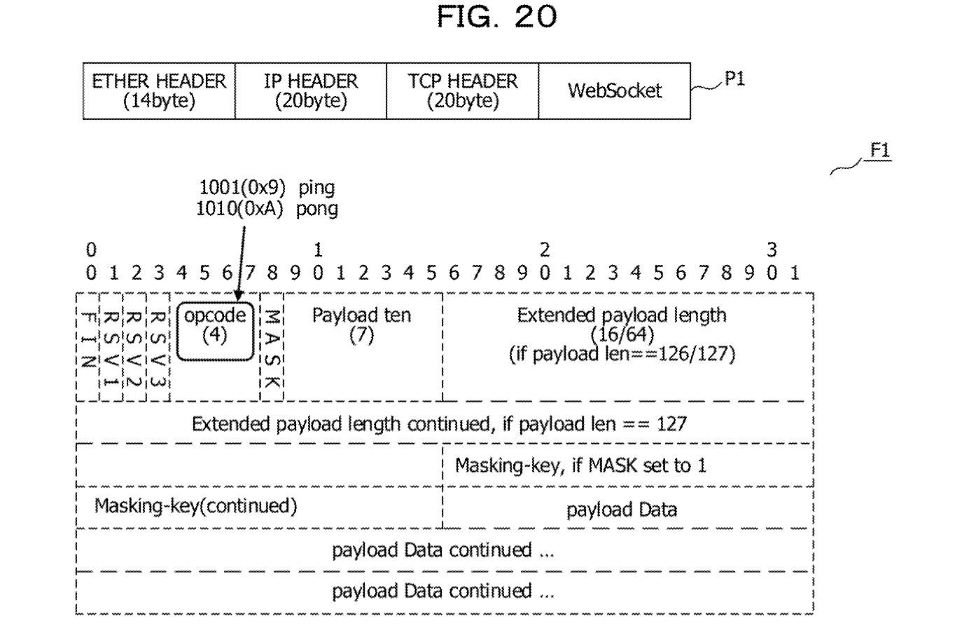

FIG. 20 illustrates an exemplary packet used for RTT measurement. A packet P1 includes an Ether header, an IP header, a TCP header, and a Websocket. An exemplary format of a data part of the Websocket is illustrated in a format F1. The format F1 includes a FIN bit, RSV1 to RSV3, an opcode field, a MASK flag, a payload length, a masking key, and payload data. If the payload length is 0 to 125 bits, the payload length is described in a Payload ten field. If the payload length is longer than 125 bits and is a length that can be described in 16 bits, the Payload ten field is set to be 126, and the payload length is expressed by a numerical value of 16 bits in an Extended payload length field. If the payload length is longer than a length that can be described in 16 bits, the Payload ten field is set to be 127. The payload length is described in subsequent 64 bits of the Payload ten field. The MASK flag indicates whether the payload data is masked. If the MASK flag is 1, the payload data is masked. The Masking key is used for a mask process.

Description of the payload data is described in the opcode field. When the opcode field is 1001 (0x9), the payload data is data of a ping packet. When the opcode field is 1010 (0xA), the payload data is data of a pong packet.

If the packet received by the measurement apparatus 30 is a ping packet or a pong packet, the analysis unit 41 may use the packet for re-calculation of RTT. The analysis unit 41 specifies the ping packet and the pong packet using the opcode field of the packet.

Values of information elements in the tables and thresholds used in the above description are illustrative only and may be changed depending on implementation. Further, data elements in the packets and formats are illustrative only and may be changed depending on implementation.

The criterion described in the fifth embodiment is illustrative only, and the thresholds used for the evaluation may be changed depending on the standard, for example, used for the communication. Further, the number of levels of communication quality may be arbitrarily changed depending on implementation.

The measurement method described above may be used for the measurement of throughput between a part of the communication apparatuses 10 and servers 20 in the communication system. For example, the measurement apparatus 30 may measure throughput only of a packet used for communication with a server 20 of a network of a specific VLAN ID.

Although a system in which a wireless section is included is described as an example in the above description, a measurement of throughput and calculation of RTT using the measurement apparatus 30 are possible even in a system in which no wireless section is included in the communication section.

Although a case where the statistical processing unit 44 obtains an average value of throughput in a plurality of connections is described as an example in the second to the fourth embodiments, the statistical processing unit 44 may calculate a statistical value other than an average value, such as the minimum value, the maximum value, a distributed value, and a standard deviation, of throughput.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A measurement apparatus comprising:
a communication device configured to obtain a packet being transmitted between a server apparatus and a communication apparatus in a network;
a memory; and
a processor coupled to the memory and configured to:
calculate round-trip time between the communication apparatus and the server apparatus based on a period of time from time at which a first packet having a length less than a threshold and transmitted to the communication apparatus from the server apparatus is acquired to time at which an acknowledgement packet transmitted in response to the first packet is acquired, and
measure a data transfer rate between the communication apparatus and the server apparatus based on a data volume included in a second packet having a length equal to or greater than the threshold and transmitted to the communication apparatus from the server apparatus, a period of time from time at which the second packet is acquired to time at which an acknowledgement packet transmitted in response to the second packet is acquired, and the round-trip time.

2. The measurement apparatus according to claim 1, wherein
the memory stores information about an access point used for a connection with the network, and information indicating a range of an address which the access point assigns to the communication apparatus connected to the access point, and
the processor further configured to:
perform a statistical process using a data transfer rate obtained in each of connections used for communication of the communication apparatus to which the address is assigned by the access point, and
output a result of the statistical process.

3. The measurement apparatus according to claim 2, wherein
when the access point assigns a first address to a first communication apparatus and assigns a second address to a second communication apparatus, the processor calculates an average value of a transfer rate measured in a connection of communication corresponding to the first address and a transfer rate measured in a connection of communication corresponding to the second address as an index value of communication quality via the access point.

4. The measurement apparatus according to claim 3, wherein
when the first communication apparatus communicates with a first server apparatus in the network and the second communication apparatus communicates with a second server apparatus in the network, the processor calculates an average value of a transfer rate measured in a connection of communication using the first address and a transfer rate measured in a connection of communication using the second address as the index value.

5. The measurement apparatus according to claim 3, wherein
the memory stores information about an access point used for a connection with the network, and identification information of a virtual network which the communication apparatus connected to the access point uses for the communication, and
the processor further configured to:
perform a statistical process using information about a data transfer rate obtained in each of connections used for transmission and reception of a packet including identification information of the virtual network, and
output a result of the statistical process.

6. A measurement method for a measurement apparatus including a communication device configured to obtain a packet being transmitted between a server apparatus and a communication apparatus in a network, a memory, and a processor coupled to the memory, comprising:
calculating round-trip time between the communication apparatus and the server apparatus based on a period of time from time at which a first packet having a length less than a threshold and transmitted to the communication apparatus from the server apparatus is acquired to time at which an acknowledgement packet transmitted in response to the first packet is acquired; and
measuring a data transfer rate between the communication apparatus and the server apparatus based on a data volume included in a second packet having a length equal to or greater than the threshold and transmitted to the communication apparatus from the server apparatus, a period of time from time at which the second packet is acquired to time at which an acknowledgement packet transmitted in response to the second packet is acquired, and the round-trip time.

7. A communication system comprising:
a server apparatus;
a communication apparatus configured to communicate with the server apparatus; and
a measurement apparatus configured to measure a data transfer rate between the server apparatus and the communication apparatus, the measurement apparatus including:
a communication device configured to obtain a packet being transmitted between the server apparatus and the communication apparatus;
a memory; and
a processor coupled to the memory and configured to:
calculate round-trip time between the communication apparatus and the server apparatus based on a period of time from time at which a first packet having a length less than a threshold and transmitted to the communication apparatus from the server apparatus is acquired to time at which an acknowledgement packet transmitted in response to the first packet is acquired, and
measure a data transfer rate between the communication apparatus and the server apparatus based on a data volume included in a second packet having a length equal to or greater than the threshold and transmitted to the communication apparatus from the server apparatus, a period of time from time at which the second packet is acquired to time at which an acknowledgement packet transmitted in response to the second packet is acquired, and the round-trip time.
